(19) United States
(12) Patent Application Publication
(10) Pub. No.: US 2026/0323334 A1
(43) Pub. Date: Oct. 15, 2026

(54) CONFIGURING AND TESTING UE REPORTING AI/ML MODEL PERFORMANCE MONITORING RESULTS

(71) Applicant: Telefonaktiebolaget LM Ericsson (publ), Stockholm (SE)

(72) Inventors: Jingya LI, Göteborg (SE); Ilmiawan SHUBHI, Malmö (SE); Henrik RYDÉN, Stockholm (SE); Yufei BLANKENSHIP, Kildeer, IL (US); Marco BELLESCHI, Solna (SE); Emil RINGH, Solna (SE)

(73) Assignee: Telefonaktiebolaget LM Ericsson (publ), Stockholm (SE)

(21) Appl. No.: 19/486,009

(22) PCT Filed: May 20, 2024
(86) PCT No.: PCT/SE2024/050488

§ 371 Date: Nov. 19, 2025

Related U.S. Application Data
(60) Provisional application No. 63/503,458, filed on May 19, 2023.

(51) Int. Cl. H04W 24/08; H04B 7/06; H04B 17/318; H04L 41/16; H04L 41/5009

(52) U.S. Cl. CPC H04W 24/08; H04B 7/0626; H04B 7/0658; H04B 17/328; H04L 41/16; H04L 41/5009

(57) ABSTRACT

A method performed by a UE for performing performance monitoring of an artificial intelligence (AI)/machine learning (ML) model in a lifecycle management (LCM). The UE receives from a network node model monitoring configuration. Furthermore, the UE derives, from the model monitoring configuration, a model performance monitoring result for the AI/ML model and reports the model performance monitoring result for the AI/ML model to the network node.

### TECHNICAL FIELD

The present disclosure is related to a user equipment (UE) performing performance monitoring of an artificial intelligence (AI)/machine learning (ML) model in a lifecycle management, a network node for configuring a UE to perform performance monitoring of an AI/ML model and methods thereof.

### BACKGROUND

Artificial Intelligence (AI) and Machine Learning (ML) have been investigated, both in academia and industry, as promising tools to optimize the design of the air-interface in wireless communication networks. Example use cases include using autoencoders for Channel State Information (CSI) compression to reduce the feedback overhead and improve channel prediction accuracy; using deep neural networks (DNNs) for classifying Line-of-Sight (LOS) and Non-LOS (NLOS) conditions to enhance the positioning accuracy; using reinforcement learning for beam selection at the network side and/or the User Equipment (UE) side to reduce the signaling overhead and beam alignment latency; and using deep reinforcement learning to learn an optimal precoding policy for complex Multiple Input Multiple Output (MIMO) precoding problems.

In 3rd Generation Partnership Project (3GPP) New Radio (NR) standardization work, a new release 18 study item on AI/ML for the NR air interface started in May 2022 RP-213599, “Study on Artificial Intelligence (AI)/Machine Learning (ML) for NR Air Interface”, Dec. 2021. This study item will explore the benefits of augmenting the air-interface with features enabling improved support of AI/ML based algorithms for enhanced performance and/or reduced complexity/overhead. Through studying a few selected use cases such as CSI feedback, beam management, and positioning this study item aims at laying the foundation for future air-interface use cases leveraging AI/ML techniques.

Building an AI model, or any ML model, includes several development steps where actual training of the AI/ML model is just one step in a training pipeline The AI/ML model lifecycle management (LCM) is illustrated in FIG. 1, which is an illustration of training and inference pipelines, in interactions within a AI/ML model LCM procedure. The model LCM may include a training (re-training) pipeline, a deployment stage, an inference pipeline, and a drift detection stage.

The training or re-training pipeline may include: data ingestion, data pre-processing, model training, model evaluation, and model registration. Data ingestion refers to gathering raw (training) data from a data storage. After data ingestion, there may also be a step that controls the validity of the gathered data. Data pre-processing refers to some feature engineering applied to the gathered data. For example, data pre-processing may include data normalization and possibly a data transformation required for the input data to the AI model. Model training refers to the actual model training steps. Model evaluation refers to benchmarking the performance to some model baseline. The iterative steps of model training and model evaluation continues until the acceptable level of performance (as previously exemplified) is achieved. Model registration refers to registering the AI model, including any corresponding AI-metadata that provides information on how the AI model was developed, and possibly AI model evaluations performance outcomes.

The deployment stage makes the trained or re-trained AI model part of the inference pipeline.

The inference pipeline may include: data ingestion, data pre-processing, model operational, and data and model monitoring. Data ingestion refers to gathering raw (inference) data from a data storage. The data pre-processing stage is typically identical to corresponding processing that occurs in the training pipeline. Model operational refers to using the trained and deployed model in an operational mode. Data and model monitoring refers to validating that the inference data are from a distribution that aligns well with the training data, as well as monitoring model outputs for detecting any performance, or operational, drifts.

The drift detection stage that informs about any drifts in the model operations.

FIG. 2 shows a functional framework that can be used for studying different NW-UE collaboration levels for the AI for PHY use cases.

The AI/ML models being discussed in the Rel-18 study item on AI/ML for the NR air interface can be categorized into the following two types: one-sided AI/ML model, and two-sided AI/ML model.

A one-sided AI/ML model can be a UE-sided AI/ML model whose inference is performed entirely at the UE. Or a one-sided AI/ML model can be a NW-sided AI/ML model whose inference is performed entirely at the NW node.

A two-sided AI/ML model refers to a paired AI/ML Model(s) over which joint inference is performed across the UE and the NW node. In such a model, the first part of the inference is performed by UE and then the remaining part is performed by the NW node, or vice versa. FIG. 3 shows an example use case of autoencoder (AE)-based two-sided CSI compression use case, where an encoder (UE-part of the two-sided AE model) is operated at a UE to compress the estimated wireless channel, and the output of the encoder (the compressed wireless channel information estimates) is reported from the UE to a NW node. The NW node uses a decoder (NW-part of the two-sided AE model) to reconstruct the estimated wireless channel information.

When applying AI/ML on air interface use cases, different levels of collaboration between network nodes and UEs can be considered including: no collaboration, limited collaboration between network nodes and UEs for one-sided models, and joint ML operation between network nodes and UEs for two-sided models.

In a case of no collaboration between network nodes and UEs, a proprietary ML model operating with the existing standard air-interface is applied at one end of the communication chain (e.g., at the UE side), and the model LCM (e.g., model selection/training, model monitoring, model retraining, model update) is done at this node without inter-node assistance (e.g., assistance information provided by the network node).

In a case of limited collaboration between network nodes and UEs for one-sided models, a ML model is operating at one end of the communication chain (e.g., at the UE side), but this node gets assistance from the node(s) at the other end of the communication chain (e.g., a next generation Node B (gNB)) for its AI model LCM to some extent (e.g., for training/retraining the AI model, model update, model monitoring, model selection/fallback/switching).

In a case of joint ML operation between network notes and UEs for two-sided models, it is assumed that the AI model is split with one part located at the network (NW) side and the other part located at the UE side. Hence, the AI model requires joint inference between the NW node and UE, and the AI model LCM involves both ends of a communication chain.

### SUMMARY

As a part of developing embodiments herein one or more problems have been identified.

There are several methods for model monitoring. Monitoring based on intermediate key performance indicators (KPIs) (e.g., inference accuracy) requires collecting new ground-truth data similar/identical to the training data, which is very accurate but has a high cost due to the potentially large measurement/reporting overhead. Monitoring based on data distribution of input/output data does not require any additional signaling overhead but is less accurate than monitoring based on inference accuracy since one does not retrieve the ground truth. Similarly, monitoring based on system performance does not require any additional signaling overhead, however, it can be challenging to detect that the root-cause for bad system performance is due to an inaccurate model, and not due to some other malfunctioning procedure or hardware. Monitoring based on data distribution can in contrast identify a potential problem in the model by detecting that the dataset observed during inference is not same as during training. However, it is not-trivial to define conditions and measurable data-distribution based KPIs for sounding a model failure alarm with a good trade-off between model failure detection reliability and accuracy (e.g., low false alarm rate, low missed detection rate and low latency).

To ensure reliable/accurate model performance monitoring results, monitoring data samples are collected and used to derive the performance monitoring results. Examples of model output accuracy based performance monitoring results include intermediate KPI per monitoring data sample, intermediate KPI statistics associated with a monitoring data set, the percentage of monitoring data samples within a monitoring dataset for which the intermediate KPI fulfills a certain condition, a flag indicating whether the model is functioning ok or not. Examples of data drift based performance monitoring results include monitoring data statistics, the difference between the monitoring data statistics and the data statistics obtained in the model training stage, a flag indicating whether a data drift is detected or not.

When implementing model monitoring, the monitoring method can be selected based on UE service requirements. For example, a UE with MBB could start with a low-cost solution (e.g., system performance based), if problems are observed/predicted, then activate an inference accuracy method associated with a higher complexity. High-complexity and signaling overhead monitoring may be required for certain UE service requirements, such as for emergency localization use cases or UEs with Ultra Reliable Low Latency Communication (URLLC) connection.

For monitoring the performance of an AI/ML model (e.g., a UE-sided model, a NW-sided model, or a two-sided model), if the performance monitoring is performed at the UE-side, then a UE can report the model performance monitoring results to the NW node so that the NW node takes the UE reported model performance information into account when making model LCM decisions (e.g., fallback to non-AL/ML algorithm, functionality switching, etc.). However, there are problems regarding how to configure a UE to derive a model performance monitoring result, and how to test/verify the quality/accuracy/reliability of the result reported from a UE.

Certain aspects of the disclosure and their embodiments may provide solutions to these or other challenges. A mechanism for a network node to configure a UE to derive a model performance monitoring result for an AI/ML model and report the result to the NW node is described. Also described is a mechanism to test the reliability/accuracy/quality of the reported result.

Certain embodiments may provide one or more of the following technical advantage(s). The proposed solution enables NW node to instruct a UE to perform performance monitoring of an AI/ML model and acquire information about the monitoring results from the UE. The proposed solution also enables the testability of the results reported from the UE, hence, the NW node can consider these results when making model LCM decisions. This is useful for some UE-sided model and two-side model cases, where UE takes full or part of responsibilities for monitoring the model performance, but still relies partly on the NW node to assist with its model LCM.

According to some embodiments, a method of operating a UE for performing performance monitoring of an AI/ML model is provided. The UE receives from a network node, model monitoring configuration. From the model monitoring configuration, a model performance monitoring result for the AI/ML model is derived. Furthermore, the UE reports the model performance monitoring result for the AI/ML model to the network node.

According to other embodiments, the model monitoring configuration comprises identification of the AI/ML model wherein the AI/ML model is for one of Channel State Information (CSI) compression, CSI prediction, beam management and/or positioning.

According to other embodiments, a method of operating a network node for configuring a UE to perform performance monitoring of an AI/ML model. The network node is signaling, to the UE, model monitoring configuration to cause the UE to derive a model performance monitoring result for the AI/ML model. The network node receives a report of the model performance monitoring result from the UE. Corresponding embodiments are also applicable for the network node.

According to other embodiments, a UE, a network node, and a host is provided to perform one of the above methods.

### BRIEF DESCRIPTION OF THE DRAWINGS

Embodiments will now be described in more detail in relation to the accompanying drawings, in which:

FIG. 1 is a flowchart illustrating embodiments of training and inference pipelines and their interactions within a model LCM procedure.

FIG. 2 is a flowchart illustrating a Model LCM.

FIG. 3 is an illustration of a Autoencoder (AE)-based two-sided CSI-compression.

FIG. 4 illustrates an example of the use of constraints to collect a representative monitoring dataset.

FIG. 5 is a flowchart illustrating a method performed by a UE according to embodiments herein,

FIG. 6 is a flowchart illustrating a method performed by a network node according to embodiments herein,

FIG. 7 illustrates an example of a communication system in accordance with some embodiments.

FIG. 8 illustrates a in accordance with some embodiments.

FIG. 9 illustrates a network node in accordance with some embodiments.

FIG. 10 is a block diagram illustrating a host in accordance with some embodiments.

FIG. 11 is a block diagram illustrating a virtualization environment in accordance with some embodiments.

FIG. 12 illustrating a communication diagram of a host communicating via a network node with a UE over a partially wireless connection in accordance with some embodiments.

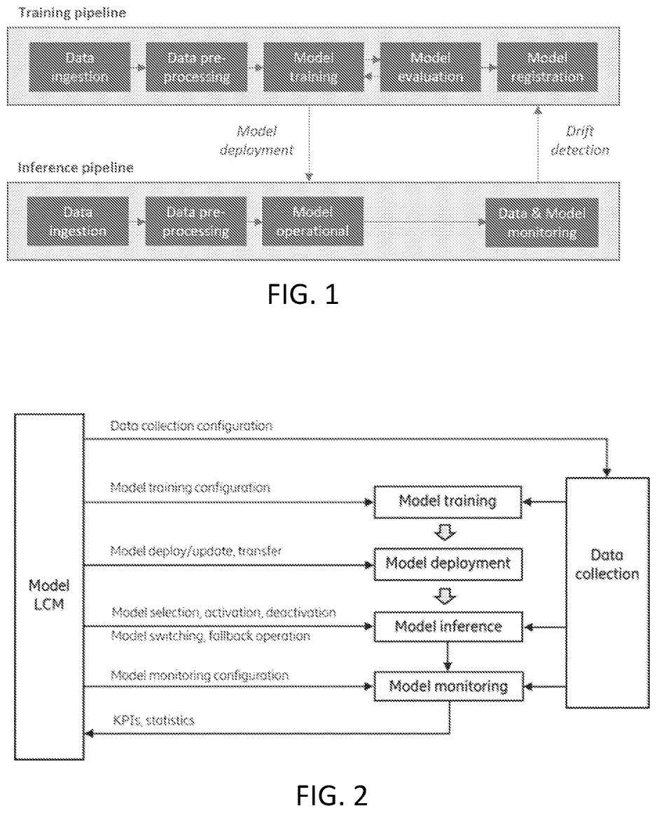

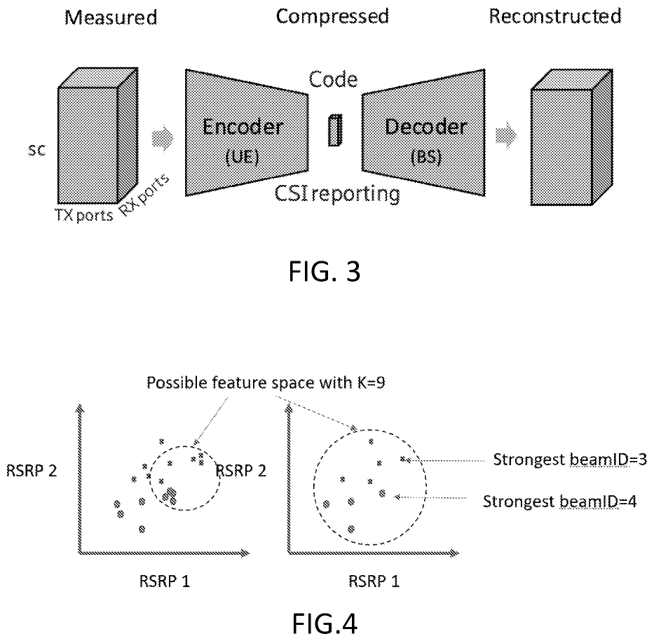

### DETAILED DESCRIPTION

Some of the embodiments contemplated herein will now be described more fully with reference to the accompanying drawings. Embodiments are provided by way of example to convey the scope of the subject matter to those skilled in the art.

To ensure reliable/accurate model performance monitoring results, monitoring data samples are collected and used to derive the performance monitoring results. Examples of model output accuracy based performance monitoring results include intermediate KPI per monitoring data sample, intermediate KPI statistics associated to a monitoring data set, the percentage of monitoring data samples within a monitoring dataset for which the intermediate KPI fulfills a certain condition, a flag indicating whether the model is functioning ok or not. Examples of data drift-based performance monitoring results include monitoring data statistics, the difference between the monitoring data statistics and the data statistics obtained in the model training stage, a flag indicating whether a data drift is detected or not.

In an embodiment, a NW node signals model monitoring configuration to a UE and the UE derives a model performance monitoring result based on this configuration and reports the result to the NW node. The NW node could be a gNB (e.g. a gNB-Central Unit (CU) or a gNB-Distributed Unit (DU)), the Operation and Maintenance System (OAM), or a core network node (e.g., the Network Data Analytics Function (NWDAF)). In the following, the term NW node can refer to any of the aforementioned NW nodes.

In an embodiment, the model monitoring configuration comprises identification of the AI/ML model wherein the AI/ML model is for one of Channel State Information (CSI) compression, CSI prediction, beam management and/or positioning.

In an embodiment the model performance monitoring results comprises an intermediate key performance indicator (KPI) per monitoring data sample, intermediate KPI statistics associated with a monitoring data set, percentage of monitoring data samples within a monitoring dataset for which the intermediate KPI fulfills a certain condition, a flag indicating whether the model is functioning or not.

In an embodiment, the model monitoring configuration includes one or more of: the AI/ML model identification; configuration for collecting monitoring data set and determining the model performance result; for the CSI compression use case: configuration of the parameters that should be used, or may be used, by the UE when conducting the monitoring of its model; the definition of intermediate KPI per monitoring data sample; the definition of model monitoring metrics; the format/content of the model performance result taken in a measurement/monitoring interval and to be reported from the UE; and the format/content of the model performance report to be reported from the UE.

The AI/ML model identification can be a functionality ID, a pairing ID, or/and a model ID.

The configuration for collecting monitoring data set and determining the model performance result can include one or more of the following: the conditions/scenarios/network configuration identification; measurement RS configurations for collecting measurement samples for model monitoring; configuration for obtaining/receiving data samples from another node; the number of samples (K) to be collected for constructing the monitoring data set (to determine the model performance result), or a minimum percentage over the number of available samples during the measurement interval needed for determining the model performance result; a constraint on the collected data samples to ensure that the collected data is representative when estimating the model monitoring performance results (as will be described in greater detail later herein); the time window for collecting monitoring data samples (i.e., the measurement interval that is used by the UE to determine the model performance result); the report interval for the reporting to the network of the monitoring results; and the conditions for the reporting to the network of the model performance result.

The conditions/scenarios/network configuration identification can include network antenna/beam configuration identification and/or the ID(s) of the area/cells from which the monitoring data samples are collected.

The measurement RS configurations for collecting measurement samples for model monitoring can include L1-Reference Signal Received Power (RSRP) measurements of SSB/CSI-RS beams for AI-based beam management use cases, CSI-RS measurements for CSI prediction use cases and two-sided CSI-compression use cases, and/or PRS measurements for positioning use cases.

The configuration for obtaining/receiving data samples from another node can include, for the two-sided CSI-compression use cases, configuration for obtaining/receiving reconstructed CSI generated from the NW-part model output or from a proxy model.

The configuration for obtaining/receiving the reconstructed CSI generated from the NW-part model output can include the format of the reconstructed CSI (e.g., represented in, for example, a certain number of beams (L), and/or delay taps (M), and/or quantization level of the coefficients), the scheduled time-frequency resources in downlink, where the NW node will transmit the reconstructed CSI, and/or a server address where the reconstructed CSI will be stored. The scheduled time-frequency resources in downlink can relate to the scheduled CSI-RS resources and/or the CSI report by a configurable rule (e.g., a configurable fixed offset).

The configuration for obtaining/receiving the reconstructed CSI generated from a proxy model can include parameters related to antenna layout and virtualization, information about compilation process and HW, information about site/cell/scenario specific adaptions/fine-tuning of the NW node decoder model, and/or one or more samples of NW-part model output of reconstructed CSI for the UE to further calibrate/fine-tune its proxy model, and these reconstructed CSI can be configured like as described with respect to the NW-part model output. The proxy model configuration can also be used for proxy models that are used to directly output an estimated/proxy intermediate KPI.

The configuration for obtaining/receiving data samples from another node can include, for an AI/ML assisted positioning method with UE-side model can include configuration for obtaining/receiving information from the location server (i.e., location management function (LMF) in NR) for the estimated ground truth of the model output, where the information can be either (a) estimated location of target UE location by LMF, or (b) estimated model output derived from the estimated location of target UE location.

The report interval for the reporting to the network of the monitoring results, used by the UE to report to the NW node one or more of the model performance results, can be equal or larger than the measurement interval.

The conditions for reporting the model performance result to the network can include the network configuring the UE to report the model performance result for one or more SSB/CSI-RS if at least one of the monitored KPI is dropping below a certain threshold. For example, if the accuracy of the prediction is dropping below a certain threshold, (e.g., RSRP difference between the predicted L1-RSRP and measured L1-RSRP is higher than a threshold), or if the UE could not acquire at least a certain percentage of monitoring samples.

For the CSI compression use case, the model monitoring configuration can include the configuration of the parameters that should be used, or may be used, by the UE when conducting the monitoring of its model, which can include one or more of: payload size of the encoder outputs, quantization methods and/or quantization sizes used to the encoder output, puncturing rate, and payload adaptation layer identifier.

As an example, for the CSI-compression use cases, the definition of intermediate KPI per monitoring data sample can be the Squared generalized cosine similarity (SGCS) and/or Normalized mean square error (NMSE) of reconstructed CSI (output from NW-part model) and the ground-truth/measured CSI. As another example, for the beam management use cases, the intermediate KPI per monitoring data sample is defined as the L1-RSRP value difference between the predicted value (model output) and the measured value of the same SSB/CSI-RS beam. As another example, for the positioning use cases, the intermediate KPI per monitoring data sample is defined as the time of arrival (ToA) value difference between the ToA produced at the model output and the estimated ToA derived from the estimated target UE location.

As an example, the model monitoring metrics is defined as the Cumulative Density Function (CDF) at X percentile(s) (e.g., 50% or/and 90%) of the intermediate KPIs associated to the collected monitoring data samples.

As another example, the model monitoring metrics is defined as the mean or/and variance of the intermediate KPIs associated to the collected monitoring data samples. The metrics is calculated for a given time window. Moreover, the time window is typically a sliding window. The time window size may be fixed or configured. Alternatively, the time window size may vary and be adaptable, so that the model monitoring window adapts to the operating status of AI/ML model. For example, the time window size is longer when no deviation of the metrics is detected, and the time window size is shorter when some deviation of the metrics is detected (i.e., the model may have performance issue).

As another example, the model monitoring metrics is defined as the percentage of the monitoring data samples for which the associated intermediate KPI values fulfills a certain condition(s), and the configuration of condition parameters. If the condition is satisfied, then the model is considered to be in normal operation for this monitoring occasion/instance; otherwise, anomaly of model operation is detected. The condition may be defined as an intermediate KPI value to be within a certain value range, where the value range is defined by one or more threshold values. The threshold values can be set by the NW node based on the metrics obtained during the model training stage (e.g., for the cases where the UE-sided model is trained at the NW node side and transferred/delivered from the NW node to the UE, or for the two-sided model cases, where the UE-part and NW-part of a two-sided model is jointly trained by the UE and NW node side, and the model performance metrics of the two-sided model is stored at the NW-side). The threshold value can be set as a function of the intermediate KPI statistics obtained during the model training stage, for example, the NW node can provide a scaling parameter α for the allowed amount of deviation from the statistics at model training stage. The statistics at model training stage can be stored as a component of the meta data of the model, so that the UE can this value when receiving the model from the model training entity. Hence, the condition for reporting the model performance monitoring result to the network node, comprises one or more threshold configured by the network node for an intermediate KPI value or a model monitoring metric.

As an example, for CSI-compression or/and CSI prediction use case, the condition can be defined as the intermediate KPI (e.g., a SGCS value) that is larger than a threshold. The threshold value can be configured as the mean value of the intermediate KPI (e.g., SGCS=X) associated with the validation data samples used during the model training stage. This assumes that the NW node knows the mean value of the intermediate KPI obtained during the model training stage (e.g., NW node is involved in the model training and stores the information about the model performance metrics associated to the validation data samples used in model training stage). The threshold value can be configured as α times the mean value of the intermediate KPI (e.g., SGCS=α*X) associated to the validation data samples used during the model training stage. For instance, if NW node signals α=0.75, then the intermediate KPI statistics is the percentage of monitored instances where the SGCS during model operation is greater than 75% of the mean value observed during model training stage. This means, if the monitored SGCS is statistically at least 75% of the mean SGCS during training, then the UE-side model can be considered in normal operation for this monitoring occasion. This threshold value configuration does not require the NW node to know the model performance metrics associated to the validation data samples used during the model training stage.

As another example, for beam management use case, the condition is defined as the intermediate KPI (e.g., a RSRP difference between the predicted L1-RSRP and measured L1-RSRP) that is below a threshold. The threshold value can be configured as the mean value of the intermediate KPI (e.g., RSRP difference (or ΔRSRP) in dB) associated with the validation data samples used during the model training stage. The threshold value can be configured as the a times the mean value of the intermediate KPI (e.g., RSRP difference (or ΔRSRP) in dB). For instance, if NW node signals α=1.5, then the model monitoring metrics is the percentage of monitored data samples where the ΔRSRP during operation is no more than 1.5 times of the mean value of ΔRSRP observed during model training stage. This means, if the monitored ΔRSRP is statistically no more than 1.5 times of ΔRSRP during training, then UE-side model can be considered in normal operation for this monitoring occasion.

The format/content of the model performance result taken in a measurement/monitoring interval and to be reported from the UE may be included in the model monitoring configuration. The model performance result includes one or more of the following contents: the measured quantity result for each measured Reference Signal (RS) (e.g., RSRP, RSRQ, SINR, RSSI, L1-RSRP), intermediate KPI per monitoring data sample, model monitoring metric(s), and a flag indicating whether the model monitoring metrics for the monitoring data samples fulfill a certain condition(s), how far is model monitoring metrics from fulfilling the condition, and the configuration of condition parameters. As an example, the flag may take two values of 0 and 1, where the flag is set to 1 if the condition is satisfied (i.e., the model is in normal operation); otherwise the flag is set to 0 if the condition is not satisfied (i.e., anomaly is detected for the UE-side model). In another example, a flag may take three values {−1, 0, 1}, where the flag is set to 1 if the condition is satisfied with a large margin (i.e., the model functions well); set to 0 if the condition is satisfied with little margin (i.e., the model functions acceptably but it may start to fail); set to −1 if the condition is not satisfied (i.e., anomaly is detected for the UE-side model and action is to be taken). In general, the flag may take a value from a pre-defined set of values, e.g., {0, 1}, {−1, 0, 1}, {−10, −5, −1, 0, 1, 5, 10}, {True, False, Neutral}.

As an example, for CSI-compression or/and CSI prediction use case, if the model monitoring metrics is defined as the mean value of the intermediated KPIs (e.g., the mean SGCS value) associated to the collected monitoring data samples, then, the condition can be defined as the mean value of the intermediate KPIs is above a certain threshold, where the threshold is configured as a (e.g., α=0.75) times the mean value of the intermediate KPI associated to the validation data samples obtained during the model training stage.

As another example, for beam management use case, if the model monitoring metrics is defined as the percentage of the monitoring data samples, for which the associated ΔRSRP is less than α (e.g., α=1.5) times of the mean value of ΔRSRP observed during model training stage, then, the condition can be defined as the percentage value is larger than a certain threshold (e.g., the threshold can be configured as 95%).

The format/content of the model performance result to be reported from the UE may be included in the model monitoring configuration. The model performance report may include one or more of the model performance results. The model performance report can be reported to the network with the periodicity of a report interval configured by the network, or upon fulfillment of a certain triggering event. In the latter case, the model performance report may just contain the model performance result for those SSB/CSI-RS for which the triggering event for reporting is fulfilled. The model performance report can be represented with a list of model performance results taken in chronological order, where each entry in the list corresponds to a model performance result. In one embodiment, an entry of the list may not contain any measured quantity results in case for example the UE was not able to acquire a number of samples to determine the measured quantity results, or the measured quantity results was not determined with accuracy. In an embodiment the model performance report is conveyed via the Minimization Drive Test (MDT) framework and terminated in the OAM/Trace Collection Entity (TCE). In another embodiment the model performance report is conveyed to the NW node.

Taking the CSI-compression use case as an example, assume that intermediate model monitoring is performed at the UE side based on the output of a proxy model, where the proxy model is a proxy NW-part model and outputs a proxy reconstructed CSI. Then, a UE can be configured with the following parameters to perform performance monitoring of a CSI-compression model, based on which the UE derives and reports the monitoring result. The monitoring result includes: the paring ID associated to the two-sided CSI-compression model, where the UE-part model is under operation at the UE; configurations for collecting the monitoring data set; the definition of intermediate KPI per monitoring data sample; the definition of model monitoring metrics; the format/content of the model performance result to be reported from the UE; and configuration to receive a few samples of NW-part model output of reconstructed CSI.

The configurations for collecting the monitoring data set include: a scenario/condition/network-configuration/area ID for the UE to select a proper proxy model for generating proxy reconstructed CSI samples, CSI-RS configurations for UE to measure and collect ground-truth/target CSI samples, the number of samples, K, to be collected for constructing the monitoring data set, which include data samples {proxy reconstructed CSI, target CSI} (this parameter may not be needed if a monitoring data collection window is configured), and the time window for collection monitoring data samples.

The definition of intermediate KPI per monitoring data sample can be the intermediate KPI per monitoring data sample k, denoted by KPI_actual (k), is configured as the SGCS between the proxy-reconstructed-CSI (k) and the target-CSI (k). That is, KPI_actual (k)=SGCS {proxy-reconstructed-CSI (k), target-CSI (k)}, for k=1, . . . , K.

The definition of model monitoring metrics may be the percentage (denoted by P_actual) of the monitoring data samples for which the associated intermediate KPI values (SGCS values) is above a certain threshold, KPI_th. The value of KPI_th is configured by the NW node directly or via a scaling parameter α, i.e., KPI_th=α×KPI_training, where KPI_training is a SGCS statistic (e.g., mean value of SGCS) observed at the model training stage, and carried as a part of the meta data of the model. Mathematically, let set A denote the monitoring data samples, and let set B denote the samples within set A that satisfies KPI_actual (k)>KPI_th. Then, P_actual=card (B)/card (A), where card (A) denotes the cardinality of the set A.

The format/content of the model performance result to be reported from the UE may include the model monitoring metrics, P_actual and/or a flag at the output the model monitoring function.

The configuration to receive a few samples of NW-part model output of reconstructed CSI can be used by the UE to further calibrate/fine-tune its proxy model and/or verify that it has selected an appropriate proxy model. Configuration of these reconstructed CSI and its transmission have been exemplified above. Methods for testing the model performance monitoring result reported by a UE are described below.

In an embodiment, multiple testing data sets are constructed for testing the performance monitoring results reported by a UE, where each testing data set consists of K data samples. The value K is the same or approximately the same as for configured by the NW node for UE to derive the model monitoring result.

In an embodiment, the testing data sets can be constructed at the NW node side, at the UE side, by a third party like OAM/network operators, or defined by 3GPP in RAN4.

In an embodiment, an actual monitoring result is generated per testing data set by reconstructing an actual monitoring data set based on the testing data set and calculating the intermediate KPI statistic using the reconstrued actual monitoring data set based on the model monitoring configuration.

In an embodiment, a ground truth monitoring result is generated per testing data set by using the testing data set based on the model monitoring configuration.

In an embodiment, the UE reported model performance monitoring result is tested/verified by comparing the actual monitoring results with the ground truth monitoring results. The comparison can be done per testing data set, or in a statistic comparison manner. The testing entity can be at the UE-side, the NW-side, or a third entity.

In an embodiment, for the CSI-compression use case, the case of rank >1, the UE may report the performance for each layer. For example, if the UE is configured with maximum rank=2, the UE may report the performance for layer 1 and layer 2. Alternatively, the UE may report only R_monitor out of R_report maximum rank. For example, if the UE is configured with maximum rank 3 (R_report=3), the UE may report only layer 1 and layer 2 (R_monitor=2). Performance for layer 3, for example, can be derived or estimated by the NW node. In another alternative, the UE may also use a method that could calculate the performance of all layers in one unified function. Here, the rank of which the UE reports its performance monitoring may be configured/configured by the NW node or may be indicated by the UE to the NW node.

Taking the CSI-compression model performance monitoring configuration discussed above as an example, in the following, we provide a few example methods for testing the UE reported monitoring result which is configured to be P_actual, for a certain a certain condition/scenario/NW node-configuration/area-configuration. The same methodology can be extended and used for testing UE reported monitoring results for different conditions/scenarios/NW node-configurations/area-configurations. The same methodology can be used for testing UE reported monitoring results based on a different performance monitoring method, e.g., using a proxy model to directly outputs a proxy intermediate KPI rather than using a proxy model to generate a proxy reconstructed CSI.

Following example describes testing method 1 that includes three steps. Step 1 of testing method 1 includes obtaining/constructing N testing data sets for the certain condition(s)/scenario(s)/NW node-configuration/area-configuration. Each testing data set n consists of K testing data samples. A testing data sample includes {proxy-reconstructed-CSI (n, k), reconstructed-CSI (n, k), target-CSI (n, k)}, with k=1, . . . , K and n=1, . . . , N. Here, the reconstructed-CSI (n, k) is the output of a real CSI reconstruction model used at the NW node or the output of a reference CSI reconstruction model associated to the target-CSI (n, k), the proxy-reconstructed-CSI (n, k) is the output of the selected proxy CSI reconstruction model used at the UE.

The testing data sets can be constructed/obtained by using the ground-truth/target CSI samples, denoted by {target-CSI (n, k)}, with n=1, . . . , N and k=1, . . . , K. The ground-truth/target CSI samples can be synthetic data samples (e.g., data samples defined in RAN4, data samples generated based on certain channel conditions and channel model parameters). The ground-truth/target CSI samples can also be the field data collected from the real-world deployment.

The following steps can be used to construct/obtain N testing data sets, denoted by {proxy-reconstructed-CSI (n, k), reconstructed-CSI (n, k), target-CSI (n, k)}, with k=1, . . . , K and n=1, . . . , N. The order of the step 1a) and step 1b) can be changed.

Step 1A: for each data set target-CSI (n, k)} for a given n, construct/obtain the K proxy reconstructed CSI samples, denoted by {proxy-reconstructed-CSI (n, k)} with k=1, . . . , K, by using the UE-part model and a selected proxy model at the UE as the following: process the K target CSI samples contained in the testing data set n, denoted by {target-CSI (n, i)}, with i=1, . . . , K, and obtain the associated K input samples to the UE-part model; and for each of the K input samples in set n, generate the proxy reconstructed CSI, denoted by {proxy-reconstructed-CSI (n, i)}, with i=1, . . . , K, using the UE-part model and the selected proxy model.

Step 1B: for each data set {target-CSI (n, k)} for a given n, construct/obtain the K reconstructed CSI samples, denoted by {reconstructed-CSI (n, k)} with k=1, . . . , K, by using the UE-part model and the NW node-part model at the NW node (or a reference proxy model) as the following: process the K target CSI samples contained in the testing data set n, denoted by {target-CSI (n, i)}, with i=1, . . . , K, and obtain the associated K input samples to the UE-part model; and for each of the K input samples in set n, generate the reconstructed CSI, denoted by {reconstructed-CSI (n, i)}, with i=1, . . . , K, using the UE-part model and the NW node-part model at the NW node (or a reference proxy model).

Step 1C: for each data set {target-CSI (n, k)} for a given n, construct/obtain the K testing data samples denoted by {proxy-reconstructed-CSI (n, k), reconstructed-CSI (n, k), target-CSI (n, k)}, with k=1, . . . , K.

Step 2 of testing method 1 includes, for each testing data set n, performing the following using the UE-part model and the selected proxy model at the UE to calculate the intermediate KPI statistic P_actual (n): derive the corresponding intermediate KPI per sample, KPI_actual (n, k)=SGCS {proxy-reconstructed-CSI (n, k), target-CSI (n, k)}, for k=1, . . . , K; and derive the model monitoring metric, P_actual for the testing data set n using KPI_actual (n, k) and the configured KPI_th. Also, for each testing data set n, perform the following to calculate the true intermediate KPI statistic P_true (n): derive the corresponding intermediate KPI per sample, KPI_true (n,k)=SGCS {reconstructed-CSI (n, k), target-CSI (n, k)}, for k=1, . . . , K; and derive the model monitoring metric, P_true for the testing data set n using KPI_ture (n, k) and the configured KPI_th.

Step 3 of testing method 1 includes obtaining the performance/accuracy/reliability of the UE reported model monitoring metric by comparing P_actual (n) with P_true (n), n=1, . . . , N, for the N testing data sets. Various statistical methods can be used to obtain the distance metric between P_actual (n) distribution and P_true (n) distribution, such as Kullback-Leibler (KL) divergence, Jensen-Shannon (JS) divergence, etc. If the distance metric is smaller than a threshold, then the test is passed, i.e., the model monitoring metric as reported by UE is acceptable; otherwise (if the distance metric is larger than a threshold), then the test is failed, i.e., the model monitoring metric as reported by UE is not reliable.

Following example describes testing method 2. In an embodiment, the NW node configures a UE to perform, multiple times, model performance monitoring of an AI/ML model and report the monitoring results together with the ground truth data samples to the NW node. Then, the NW node compares the received monitoring results from the UE with its own derived monitoring results to verify/test the reliability/accuracy/performance of the UE reported monitoring results.

Taking the CSI-compression model performance monitoring configuration discussed above as an example, the following three steps can be used for testing the performance of a UE reported model performance monitoring result. Step 1 of testing method 2 includes the NW node configuring a UE to perform N times of model performance monitoring for the CSI-compression model and report monitoring results to the NW node. For each model performance monitoring, the configuration parameters discussed above related to the configuration for a UE to derive and report a model performance monitoring result can be used for the UE to derive the performance monitoring result.

Step 2 of testing method 2 includes, for each performance monitoring occasion n, the UE deriving the monitoring result (e.g., P_actual (n)) based on the received model monitoring configuration, the UE reporting the derived monitoring results (e.g., P_actual (n)) together with the target CSI (e.g., target-CSI (n, k) with k=1, . . . , K) collected for this performance monitoring occasion n to the NW node, and the NW node deriving a model performance result (e.g., P_true (n)) using the reconstructed CSI samples generated from its NW node-part model output (e.g., {reconstructed-CSI (n, i)}, with i=1, . . . , K) and the target CSI received from the UE (e.g., {target-CSI (n, k)} with k=1, . . . , K), using the same monitoring result derivation method (i.e., the model monitoring configuration signaled from the NW node to the UE).

In an embodiment, the definition of the model monitoring metrics (e.g., P_*(n)) is chosen so that no assistance information needs to be sent from UE to NW node. For example, the model monitoring metrics can be: (a) the intermediate KPI value at CDF=X %; or (b) mean value of intermediate KPIs; (c) variance of intermediate KPIs; etc. In an embodiment, the definition of the intermediate KPI statistics P_*(n) may require the UE to send assistance information to the NW node, where the assistance information is a type of meta data about the UE's model. For example, if the definition of P_*(n) requires statistics from the model training stage (e.g., SGCS observed at the model training stage), then the NW node need to receive such information from the UE. It is noted that different UE may have different values (e.g., different SGCS at the model training stage) for its model.

Step 3 of testing method 2 includes the NW node deriving/obtaining the performance/accuracy/reliability of the UE reported model monitoring result by comparing the UE reported monitoring results (P_actual (n)) with its own derived model performance results (P_true (n)) for the N monitoring occasions, n=1, . . . , N. Various statistical methods can be used to obtain the distance metric between P_actual (n) distribution and P_true (n) distribution, e.g., Kullback-Leibler (KL) divergence, Jensen-Shannon (JS) divergence, etc. If the distance metric is smaller than a threshold, then the test is passed, i.e., the model monitoring metric as reported by UE is acceptable; otherwise (if the distance metric is larger than a threshold), then the test is failed, i.e., the model monitoring metric as reported by UE is not reliable.

In the above embodiments, the configurations for the model monitoring are configured by the NW node. It should be noted that part of the configurations may also be defined in the standard text. For example, for the CSI compression use case, instead of receiving configurations related to the applied quantization size, the standard text may also define, e.g., that the UE should use a certain quantization size. In one example of implementation, the quantization size may be the largest possible quantization size (that is supported by the UE and/or the NW node for the respected model or model pair) in deriving the performance monitoring metric. Similarly, the UE may be predetermined, e.g., in the standard text that in deriving its performance monitoring metric, the UE should apply a certain payload size. In an example of implementation, the payload size is the largest payload size that is supported by the UE and/or the NW node for the respected model and/or model pair. The similar may also be applied for the latent space size, puncturing rate, and the payload adaptation layer.

In an embodiment, transmission of multiple results in one report may also be supported. For example, the UE may report the monitoring results for more than one model (or model pair), more than one payload sizes, quantization sizes, etc. In transmitting the report, the UE may attach the identifier to the report, for example, identifier of the model (or model pair), quantization size, payload size, etc., that is used by the UE for each of the monitoring results inside the report.

In an embodiment, the UE may be configured with multiple values in the performance monitoring configurations. The UE may apply one value for each configuration and report its selected values in the performance monitoring report.

Having a “rich” monitoring dataset is important when testing a model's performance. A rich dataset provides a diverse and representative sample of the underlying problem domain. It ensures that the model has been exposed to a wide range of scenarios, variations, and edge cases. In case the K samples for model monitoring is measured during a short time window, it is highly likely that they are correlated which might imply that the monitoring results are effectively only based on a single/few samples. The NW node can further indicate/signal (spec-impact) the UE on certain constraints when collecting the monitoring data, to ensure a rich monitoring dataset, for example, the constraints can be one or more of the following.

In one embodiment the constraints include the condition that only one sample of channel/radio measurement data (e.g., CSI-RS measurement) can be collected in a channel coherence time/frequency interval. Or within a certain time-window (e.g., maximum 10 samples every second). Or a maximum number for each cell or site-ID or area ID or UE geolocation.

The NW node can in an embodiment indicate a decision criteria for UEs including a new monitoring sample, for example based on the Eucledian distance, The decision on how to rate (in terms of novelty) a new sample for a given existing dataset can be based on a function, denoted by a decision criterion hereafter. One such function, as a non-limiting example, can be the weighted Euclidian distance compared to the other samples in the database. The weighted Euclidian distance d, this can be calculated for the n features by:

$$d = \sqrt{{\sum }_{i = 1}^{n} {{w}_{i} ( {x}_{d} - x )}^{2}} ,$$

$$d ∈ D$$

Another type of decision criterion could be based on some of the available distance metrics in the literature. Some non-limiting examples include Manhattan (L1-norm), Euclidean (L2-norm), Minkowski, Cosine and Chebychev type of distance metrics.

In case of supervised learning, the UE compares the distance with the samples within its own target class. Some non-limiting examples using the distance to determine the importance of a sample include density-based approaches, proximity approaches (maximum distance to other points, average distance to other points etc.). Or in case of regression, only the samples within a range of its target regression variable are being used.

In one example, only two-features are shown for simplicity in FIG. 4 the UE can only use the rightmost samples as part of its monitoring database when including a constraint on how to collect the monitoring data samples. Without a constraint, there is a risk that the collected data might be located in an isolated feature space area, not being able to perform accurate monitoring results. Feature 1 could in this example be the RSRP measurement of beamID=0, and Feature 2 could in this example be the RSRP measurement of beamID=1. The class denoted by “x” or “o” could represent the strongest narrow beam ID, e.g. beamID2 or beamID=3. FIG. 4 illustrates an example of the use of constraints to collect a representative monitoring dataset, when collecting K-9 samples. The left side of FIG. 4 shows the UE collecting measurements without constraints. The right side of FIG. 4 shows constraints based on Euclidian distance. FIG. 4 shows that it is possible that without constraints the UE risks on having a non-representative dataset when estimating the model performance results.

A model performance result reported by the UE to the network can be conveyed in the MeasResultNR as follows. Changes to the current legacy are underlined.

| | |
|---|---|
| MeasResultNR ::= | SEQUENCE { |
| physCellId | PhysCellId |

OPTIONAL,

| | |
|---|---|
| measResult | SEQUENCE { |
| cellResults | SEQUENCE{ |
| resultsSSB-Cell | MeasQuantityResults |

OPTIONAL,

| | |
|---|---|
| resultsCSI-RS-Cell | MeasQuantityResults |

OPTIONAL
},

| | |
|---|---|
| rsIndexResults | SEQUENCE{ |
| resultsSSB-Indexes | ResultsPerSSB-IndexList |

OPTIONAL,

| | |
|---|---|
| resultsCSI-RS-Indexes | ResultsPerCSI-RS- |
| IndexList | OPTIONAL |

```
    }
OPTIONAL
  },
  ...,
  [[
```

| | |
|---|---|
| cgi-Info | CGI-InfoNR |

```
OPTIONAL,
  ]] ,
  [[
```

| | |
|---|---|
| choCandidate-r17 | ENUMERATED {true} |

OPTIONAL,

| | |
|---|---|
| choConfig-r17 | SEQUENCE (SIZE (1..2)) OF |
| CondTriggerConfig-r16 | OPTIONAL, |
| triggeredEvent-r17 | SEQUENCE { |
| timeBetweenEvents-r17 | TimeBetweenEvent-r17 |

OPTIONAL,

| | |
|---|---|
| firstTriggeredEvent | ENUMERATED {condFirstEvent, |
| condSecondEvent} | OPTIONAL |

```
    }
OPTIONAL
  ]],
  [[
```

| | |
|---|---|
| kpiResultsPerSSB | SEQUENCE (SIZE |

(1..maxNrofIndexesToReport2)) OF KPIResults-r18

| | |
|---|---|
| kpiResultsPerCSI-RS | SEQUENCE (SIZE |

(1..maxNrofIndexesToReport2)) OF KPIResults-r18
]]
}

| | |
|---|---|
| KPIResults ::= | SEQUENCE { |
| accuracy | ENUMERATED {p20, p40, p60, p80} OPTIONAL, |
| sampleMonitored | ENUMERATED {p20, p40, p60, p80} OPTIONAL, |

```
  [one or more format/content of the model performance result discussed in
section related to configuration for a UE to derive and report a model
performance monitoring result.]
  ....
}
```

accuracy
This field indicates the accuracy of the beam level measurement, e.g. the percentage gap
between the between the predicted L1-RSRP and measured L1-RSRP is higher than a
threshold, averaged over the measurement interval. Value p20 indicates that the accuracy is
below 20%, value p40 indicates that the accuracy is between 40% and 20%, and so on.
sampleMonitored
This field indicates the percentage of samples that were used to determine the measured
quantity results over the available measurement samples within the measurement interval.
Value p20 indicates that the less than 20% samples were used, value p40 indicates that the
between 40% and 20% samples were used, and so on.
kpiResultsPerSSB
This field includes the AIML-related KPI results for each beam level measurement results
based on SS/PBCH related measurements included in resultsSSB-Indexes
kpiResultsPerCSI-RS
This field includes the AIML-related KPI results for each beam level measurement results
based on CSI-RS related measurements included in resultsCSI-RS-Indexes.

For the configuration, the following modifications may be needed (the modifications represented by underlining):

| | |
|---|---|
| EventTriggerConfig::= | SEQUENCE { |
| eventId | CHOICE { |
| eventA1 | SEQUENCE { |
| a1-Threshold | MeasTriggerQuantity, |
| reportOnLeave | BOOLEAN, |
| hysteresis | Hysteresis, |
| timeToTrigger | TimeToTrigger |

},

| | |
|---|---|
| eventA2 | SEQUENCE { |
| a2-Threshold | MeasTriggerQuantity, |
| reportOnLeave | BOOLEAN, |
| hysteresis | Hysteresis, |
| timeToTrigger | TimeToTrigger |

},

| | |
|---|---|
| eventA3 | SEQUENCE { |
| a3-Offset | MeasTriggerQuantityOffset, |
| reportOnLeave | BOOLEAN, |
| hysteresis | Hysteresis, |
| timeToTrigger | TimeToTrigger, |
| useAllowedCellList | BOOLEAN |

},

| | |
|---|---|
| eventA4 | SEQUENCE { |
| a4-Threshold | MeasTriggerQuantity, |
| reportOnLeave | BOOLEAN, |
| hysteresis | Hysteresis, |
| timeToTrigger | TimeToTrigger, |
| useAllowedCellList | BOOLEAN |

},

| | |
|---|---|
| eventA5 | SEQUENCE { |
| a5-Threshold1 | MeasTriggerQuantity, |
| a5-Threshold2 | MeasTriggerQuantity, |
| reportOnLeave | BOOLEAN, |
| hysteresis | Hysteresis, |
| timeToTrigger | TimeToTrigger, |
| useAllowedCellList | BOOLEAN |

},

| | |
|---|---|
| eventA6 | SEQUENCE { |
| a6-Offset | MeasTriggerQuantityOffset, |
| reportOnLeave | BOOLEAN, |
| hysteresis | Hysteresis, |
| timeToTrigger | TimeToTrigger, |
| useAllowedCellList | BOOLEAN |

```
    },
    ...,
    [[
```

| | |
|---|---|
| eventX1-r17 | SEQUENCE { |
| x1-Threshold1-Relay-r17 | SL-MeasTriggerQuantity-r16, |
| x1-Threshold2-r17 | MeasTriggerQuantity, |
| reportOnLeave-r17 | BOOLEAN, |
| hysteresis-r17 | Hysteresis, |
| timeToTrigger-r17 | TimeToTrigger, |
| useAllowedCellList-r17 | BOOLEAN |

},

| | |
|---|---|
| eventX2-r17 | SEQUENCE { |
| x2-Threshold-Relay-r17 | SL-MeasTriggerQuantity-r16, |
| reportOnLeave-r17 | BOOLEAN, |
| hysteresis-r17 | Hysteresis, |
| timeToTrigger-r17 | TimeToTrigger |

},

| | |
|---|---|
| eventD1-r17 | SEQUENCE { |
| distanceThreshFromReference1-r17 | INTEGER(1.. 65525), |
| distanceThreshFromReference2-r17 | INTEGER(1.. 65525), |
| referenceLocation1-r17 | ReferenceLocation-r17, |
| referenceLocation2-r17 | ReferenceLocation-r17, |
| reportOnLeave-r17 | BOOLEAN, |
| hysteresisLocation-r17 | HysteresisLocation-r17, |
| timeToTrigger-r17 | TimeToTrigger |

```
    }
    ]]
  },
```

| | |
|---|---|
| rsType | NR-RS-Type, |
| reportInterval | ReportInterval, |
| reportAmount | ENUMERATED {r1, r2, r4, r8, r16, r32, r64, |

infinity},

| | |
|---|---|
| reportQuantityCell | MeasReportQuantity, |
| maxReportCells | INTEGER (1..maxCellReport), |
| reportQuantityRS-Indexes | MeasReportQuantity |

OPTIONAL, -- Need R

| | |
|---|---|
| maxNrofRS-IndexesToReport | INTEGER (1..maxNrofIndexesToReport) |

OPTIONAL, -- Need R

| | |
|---|---|
| includeBeamMeasurements | BOOLEAN, |
| reportAddNeighMeas | ENUMERATED {setup} |

```
OPTIOANL, -- Need R
  ...,
  [[
```

| | |
|---|---|
| measRSSI-ReportConfig-r16 | MeasRSSI-ReportConfig-r16 |

OPTIONAL, -- Need R

| | |
|---|---|
| useT312-r16 | BOOLEAN |

OPTIONAL, -- Need M

| | |
|---|---|
| includeCommonLocationInfo-r16 | ENUMERATED {true} |

OPTIONAL, -- Need R

| | |
|---|---|
| includeBT-Meas-r16 | SetupRelease {BT-NameList-r16} |

OPTIONAL, -- Need M

| | |
|---|---|
| includeWLAN-Meas-r16 | SetupRelease {WLAN-NameList-r16} |

OPTIONAL, -- Need M

| | |
|---|---|
| includeSensor-Meas-r16 | SetupRelease {Sensor-NameList-r16} |

```
OPTIONAL -- Need M
  ]],
  [[
```

| | |
|---|---|
| coarseLocationRequest-r17 | ENUMERATED {true} |

OPTIONAL, -- Need R

| | |
|---|---|
| reportQuantityRelay-r17 | SL-MeasReportQuantity-r16 |

```
OPTIONAL -- Need R
  ]],
  [[
```

| | |
|---|---|
| kpisTriggeringEvents | KPIsTriggeringEvents |
| reportQuantityKPIs | ReportQuantityKPIs |

```
  one or more model monitoring cofiguration
  parameters discussed in section 2.7.1.2
  ]]
}
```

| | |
|---|---|
| PeriodicalReportConfig ::= | SEQUENCE { |
| rsType | NR-RS-Type, |
| reportInterval | ReportInterval, |
| reportAmount | ENUMERATED {r1, r2, r4, r8, r16, r32, r64, |

infinity},

| | |
|---|---|
| reportQuantityCell | MeasReportQuantity, |
| maxReportCells | INTEGER (1..maxCellReport), |
| reportQuantityRS-Indexes | MeasReportQuantity |

OPTIONAL, -- Need R

| | |
|---|---|
| maxNrofRS-IndexesToReport | INTEGER (1..maxNrofIndexesToReport) |

OPTIONAL, -- Need R

| | |
|---|---|
| includeBeamMeasurements | BOOLEAN, |
| useAllowedCellList | BOOLEAN, |

```
  ...,
  [[
```

| | |
|---|---|
| measRSSI-ReportConfig-r16 | MeasRSSI-ReportConfig-r16 |

OPTIONAL, -- Need R

| | |
|---|---|
| includeCommonLocationInfo-r16 | ENUMERATED {true} |

OPTIONAL, -- Need R

| | |
|---|---|
| includeBT-Meas-r16 | SetupRelease {BT-NameList-r16} |

OPTIONAL, -- Need M

| | |
|---|---|
| includeWLAN-Meas-r16 | SetupRelease {WLAN-NameList-r16} |

OPTIONAL, -- Need M

| | |
|---|---|
| includeSensor-Meas-r16 | SetupRelease {Sensor-NameList-r16} |

OPTIONAL, -- Need M

| | |
|---|---|
| ul-DelayValueConfig-r16 | SetupRelease { UL-DelayValueConfig-r16 } |

OPTIONAL, -- Need M

| | |
|---|---|
| reportAddNeighMeas-r16 | ENUMERATED {setup} |

```
OPTIONAL -- Need R
  ]],
  [[
```

| | |
|---|---|
| ul-ExcessDelayConfig-r17 | SetupRelease { UL-ExcessDelayConfig-r17 } |

OPTIONAL, -- Need M

| | |
|---|---|
| coarseLocationRequest-r17 | ENUMERATED {true} |

OPTIONAL, -- Need R

| | |
|---|---|
| reportQuantityRelay-r17 | SL-MeasReportQuantity-r16 |

OPTIONAL -- Need R
]]

| | |
|---|---|
| reportQuantityKPIs | ReportQuantityKPIs |

}

| | |
|---|---|
| ReportQuantityKPIs | SEQUENCE { |
| measurementInterval | ENUMERATED {10ms, 20ms, |
| | 40ms, 60ms} OPTIONAL, |
| samplesToBeMonitored | ENUMERATED {10, 20, 40, 60} OPTIONAL, |
| accuracy | ENUMERATED {true} OPTIONAL, |
| sampleMonitored | ENUMERATED {true} OPTIONAL, |

```
  one or more model monitoring metrics discussed in section 2.7.1.2
  ...
}
```

| | |
|---|---|
| KPIsTriggeringEvents | SEQUENCE { |
| accuracyTriggering | ENUMERATED {p20, p40, p60, p80} OPTIONAL, |
| sampleMonitoredTriggering | ENUMERATED {p20, p40, p60, p80} OPTIONAL, |

....
}

measurementInterval
This field indicates the measurement interval in ms under which the UE shall perform
the model performance monitoring and determine the associated results.
sampleToBeMonitored
This field indicates the minimum number of samples that the UE shall acquire to
determine the model performance monitoring results.
accuracy
If this field is set to true, the UE shall report the accuracy results in the measurement
report
samplesMonitored
It this field is set to true, the UE shall report the percentage of the samples monitored
results in the measurement report
accuracyTriggering
This field indicates the conditions under which the UE shall report the measurement
results to the network. If the field is set to p20, the UE shall report the measurement
results to the network if the accuracy is below 20%, and so on. If the field is set to
p40, the UE shall report the measurement results to the network if the accuracy is
between 20% and 40%, and so on.
samplesMonitoredTriggering
This field indicates the conditions under which the UE shall report the measurement
results to the network. If the field is set to p20, the UE shall report the measurement
results to the network if the percentage of monitored samples used for the
determination of the measurement results is below 20%, and so on. If the field is set
to p40, the UE shall report the measurement results to the network if the percentage
of monitored samples used for the determination of the measurement results is
between 20% and 40%, and so on.

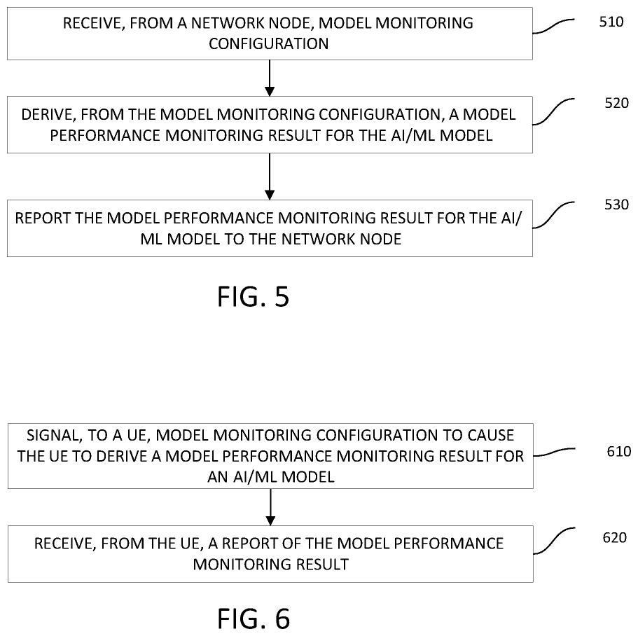

FIG. 5 is a flowchart of an example method for a UE for performing performance monitoring of an AI/ML model.

At operation 510, the UE receives, from a network node, model monitoring configuration. The network node may be a gNB, OAM, or a core network node. The model monitoring configuration may include one or more of the following: an identification of the AI/ML model, wherein the AI/ML model may be for one or more of Channel State Information (CSI) compression, CSI prediction, beam management and/or positioning; one or more configurations for collecting a monitoring data set and determining model performance result. The model performance monitoring result may comprises an intermediate key performance indicator (KPI) per monitoring data sample, intermediate KPI statistics associated with a monitoring data set, percentage of monitoring data samples within a monitoring data set for which the intermediate KPI fulfills a certain condition, a flag indicating whether the model is functioning or not; a definition of an intermediate key performance indicator (KPI) per monitoring data sample; a definition of model monitoring metrics; a content of the model performance monitoring result; and a content of the reporting of the model performance monitoring result.

The one or more configurations for collecting the monitoring data set and determining model performance result may include one or more of the following: an identification of a condition such as a network antenna/beam configuration and/or an identifier of one or more areas/cells from which monitoring data samples are to be collected; measurement reference signal (RS) configurations for collecting measurement samples; configuration for obtaining or receiving data samples from another node; a number of samples to be collected for constructing the monitoring data set; a constraint on the number of samples that are collected; a time window for collecting the number of samples; a report interval for reporting of the model performance monitoring result; and a condition for reporting of the model performance monitoring result to the network node.

The AI/ML model may be for a two-sided channel state information (CSI)-compression use case. The configuration for obtaining or receiving data samples from another node may include configuration for obtaining or receiving reconstructed CSI from a network node-part model output or from a proxy model.

The AI/ML model may be for an assisted positioning method with UE-side model. The configuration for obtaining or receiving data samples from another node may include configuration for obtaining or receiving information from a location server for an estimated ground truth of an output of the AI/ML model.

The definition of the intermediate KPI per monitoring data sample may be one of: a squared generalized cosine similarity (SGCS) and/or normalized mean square error (NMSE) of reconstructed channel state information (CSI) and measured CSI; a L1-reference signal received power (RSRP) value difference between a predicted value and a measured value of a same Synchronization Signal Block (SSB)/CSI-reference signal (RS) beam; and a time of arrival (ToA) value difference between the ToA produced at model output and an estimated ToA derived from an estimated target UE location.

The definition of model monitoring metrics may be one of: a Cumulative Density Function (CDF) at X percentile of intermediate key performance indicators (KPIs) associated with collected monitoring data samples; a mean and/or variance of the intermediate KPIs associated with collected monitoring data samples; and a percentage of collected monitoring data samples for which the intermediate KPIs associated with the collected monitoring data samples fulfill a condition.

The content of the model performance monitoring result may include one or more of: a measured quantity result for each measured RS; intermediate KPI per monitoring data sample; one or more model monitoring metrics; and a flag indicating whether the one or more model monitoring metrics fulfill a condition.

The content of the reporting of the model performance monitoring result may include one or more of the performance of the model performance monitoring results.

At operation 520, the UE derives, from the model monitoring configuration, a model performance monitoring result for the AI/ML model. At step 530, the UE reports the model performance monitoring result for the AI/ML model to the network node. The model performance monitoring result report can be reported to the network node with the periodicity of a report interval configured by the network node, or upon fulfillment of a certain triggering event. In the latter case, the model performance report may just contain the model performance result for those SSB/CSI-RS for which the triggering event for reporting is fulfilled. The model performance report can be represented with a list of model performance results taken in chronological order, where each entry in the list corresponds to model performance result. In one embodiment an entry of the list may not contain any measured quantity results in case for example the UE was not able to acquire a number of samples to determine the measured quantity results, or the measured quantity results was not determined with accuracy. The model performance report may be conveyed via the MDT framework and terminated in the OAM/TCE. In another embodiment the model performance report is conveyed to the NW node.

FIG. 6 is a flowchart of an example method for a network node for configuring a UE to perform performance monitoring of an AI/ML model.

At operation 610, the network node signals, to the UE, model monitoring configuration to cause the UE to derive a model performance monitoring result for the AI/ML model. The network node may be a gNB, OAM, or a core network node. The model monitoring configuration may include one or more of the following: an identification of the AI/ML model; one or more configurations for collecting a monitoring data set and determining model performance result; a definition of an intermediate key performance indicator (KPI) per monitoring data sample; a definition of model monitoring metrics; a content of the model performance monitoring result; and a content of the reporting of the model performance monitoring result.

The one or more configurations for collecting the monitoring data set and determining model performance result may include one or more of the following: an identification of a condition such as a network antenna/beam configuration and/or an identifier of one or more areas/cells from which monitoring data samples are to be collected; measurement reference signal (RS) configurations for collecting measurement samples; configuration for obtaining or receiving data samples from another node; a number of samples to be collected for constructing the monitoring data set; a constraint on the number of samples that are collected; a time window for collecting the number of samples; a report interval for reporting of the model performance monitoring result; and a condition for reporting of the model performance monitoring result to the network node.

The AI/ML model may be for a two-sided channel state information (CSI)-compression use case. The configuration for obtaining or receiving data samples from another node may include configuration for obtaining or receiving reconstructed CSI from a network node-part model output or from a proxy model.

The AI/ML model may be for an assisted positioning method with UE-side model. The configuration for obtaining or receiving data samples from another node may include configuration for obtaining or receiving information from a location server for an estimated ground truth of an output of the AI/ML model.

The definition of the intermediate KPI per monitoring data sample may be one of: a squared generalized cosine similarity (SGCS) and/or normalized mean square error (NMSE) of reconstructed channel state information (CSI) and measured CSI; a L1-reference signal received power (RSRP) value difference between a predicted value and a measured value of a same Synchronization Signal Block (SSB)/CSI-reference signal (RS) beam; and a time of arrival (ToA) value difference between the ToA produced at model output and an estimated ToA derived from an estimated target UE location.

The definition of model monitoring metrics may be one of: a Cumulative Density Function (CDF) at X percentile of intermediate key performance indicators (KPIs) associated with collected monitoring data samples; a mean and/or variance of the intermediate KPIs associated with collected monitoring data samples; and a percentage of collected monitoring data samples for which the intermediate KPIs associated with the collected monitoring data samples fulfill a condition.

The content of the model performance monitoring result may include one or more of: a measured quantity result for each measured RS; intermediate KPI per monitoring data sample; one or more model monitoring metrics; and a flag indicating whether the one or more model monitoring metrics fulfill a condition.

The content of the reporting of the model performance monitoring result may include one or more of the performance of the model performance monitoring results.

At operation 620, the network node receives, from the UE, a report of the model performance monitoring result. The model performance monitoring result report can be received at the network node with the periodicity of a report interval configured by the network node, or upon fulfillment of a certain triggering event. In the latter case, the model performance report may just contain the model performance result for those SSB/CSI-RS for which the triggering event for reporting is fulfilled. The model performance report can be represented with a list of model performance results taken in chronological order, where each entry in the list corresponds to model performance result. In one embodiment an entry of the list may not contain any measured quantity results in case for example the UE was not able to acquire a number of samples to determine the measured quantity results, or the measured quantity results was not determined with accuracy. The model performance report may be conveyed via the MDT framework and terminated in the OAM/TCE. In another embodiment the model performance report is conveyed to the NW node.

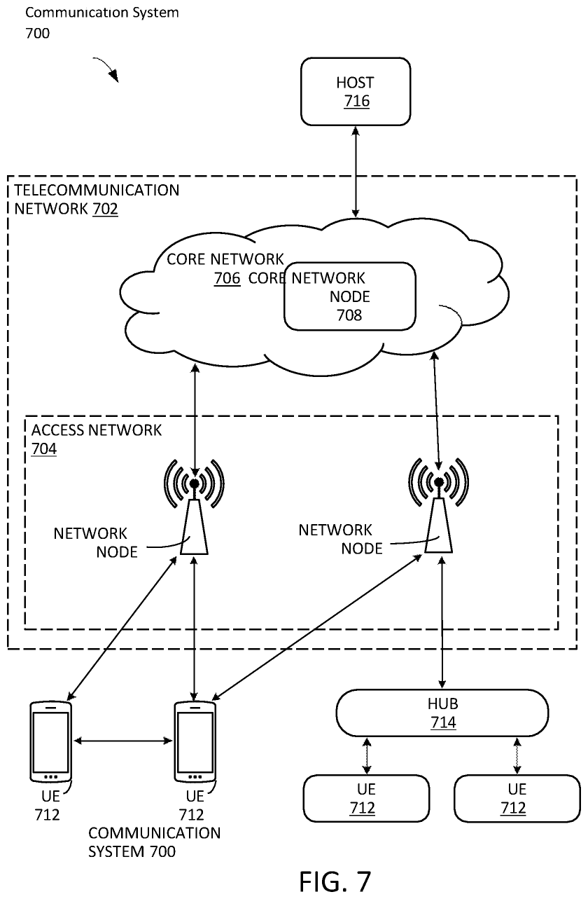

FIG. 7 shows an example of a communication system 700 in accordance with some embodiments.

In the example, the communication system 700 includes a telecommunication network 702 that includes an access network 704, such as a radio access network (RAN), and a core network 706, which includes one or more core network nodes 708. The access network 704 includes one or more access network nodes, such as network nodes 710a and 710b (one or more of which may be generally referred to as network nodes 710), or any other similar 3rd Generation Partnership Project (3GPP) access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network 702 includes one or more Open-RAN (ORAN) network nodes. An ORAN network node is a node in the telecommunication network 702 that supports an ORAN specification (e.g., a specification published by the O-RAN Alliance, or any similar organization) and may operate alone or together with other nodes to implement one or more functionalities of any node in the telecommunication network 702, including one or more network nodes 710 and/or core network nodes 708.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes 710 facilitate direct or indirect connection of UE, such as by connecting UEs 712a, 712b, 712c, and 712d (one or more of which may be generally referred to as UEs 712) to the core network 706 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 700 may include any number of wired or wireless networks, network nodes, UEs, and/or any other components or systems that may facilitate or participate in the communication of data and/or signals whether via wired or wireless connections. The communication system 700 may include and/or interface with any type of communication, telecommunication, data, cellular, radio network, and/or other similar type of system.

The UEs 712 may be any of a wide variety of communication devices, including wireless devices arranged, configured, and/or operable to communicate wirelessly with the network nodes 710 and other communication devices. Similarly, the network nodes 710 are arranged, capable, configured, and/or operable to communicate directly or indirectly with the UEs 712 and/or with other network nodes or equipment in the telecommunication network 702 to enable and/or provide network access, such as wireless network access, and/or to perform other functions, such as administration in the telecommunication network 702.

In the depicted example, the core network 706 connects the network nodes 710 to one or more hosts, such as host 716. These connections may be direct or indirect via one or more intermediary networks or devices. In other examples, network nodes may be directly coupled to hosts. The core network 706 includes one more core network nodes (e.g., core network node 708) that are structured with hardware and software components. Features of these components may be substantially similar to those described with respect to the UEs, network nodes, and/or hosts, such that the descriptions thereof are generally applicable to the corresponding components of the core network node 708. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 716 may be under the ownership or control of a service provider other than an operator or provider of the access network 704 and/or the telecommunication network 702, and may be operated by the service provider or on behalf of the service provider. The host 716 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 700 of FIG. 7 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 702 is a cellular network that implements 3GPP standardized features. Accordingly, the telecommunications network 702 may support network slicing to provide different logical networks to different devices that are connected to the telecommunication network 702. For example, the telecommunications network 702 may provide URLLC services to some UEs, while providing Enhanced Mobile Broadband (eMBB) services to other UEs, and/or Massive Machine Type Communication (mMTC)/Massive IoT services to yet further UEs.

In some examples, the UEs 712 are configured to transmit and/or receive information without direct human interaction. For instance, a UE may be designed to transmit information to the access network 704 on a predetermined schedule, when triggered by an internal or external event, or in response to requests from the access network 704. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 714 communicates with the access network 704 to facilitate indirect communication between one or more UEs (e.g., UE 712c and/or 712d) and network nodes (e.g., network node 710b). In some examples, the hub 714 may be a controller, router, content source and analytics, or any of the other communication devices described herein regarding UEs. For example, the hub 714 may be a broadband router enabling access to the core network 706 for the UEs. As another example, the hub 714 may be a controller that sends commands or instructions to one or more actuators in the UEs. Commands or instructions may be received from the UEs, network nodes 710, or by executable code, script, process, or other instructions in the hub 714. As another example, the hub 714 may be a data collector that acts as temporary storage for UE data and, in some embodiments, may perform analysis or other processing of the data. As another example, the hub 714 may be a content source. For example, for a UE that is a VR headset, display, loudspeaker or other media delivery device, the hub 714 may retrieve VR assets, video, audio, or other media or data related to sensory information via a network node, which the hub 714 then provides to the UE either directly, after performing local processing, and/or after adding additional local content. In still another example, the hub 714 acts as a proxy server or orchestrator for the UEs, in particular if one or more of the UEs are low energy IoT devices.

The hub 714 may have a constant/persistent or intermittent connection to the network node 710b. The hub 714 may also allow for a different communication scheme and/or schedule between the hub 714 and UEs (e.g., UE 712c and/or 712d), and between the hub 714 and the core network 706. In other examples, the hub 714 is connected to the core network 706 and/or one or more UEs via a wired connection. Moreover, the hub 714 may be configured to connect to an M2M service provider over the access network 704 and/or to another UE over a direct connection. In some scenarios, UEs may establish a wireless connection with the network nodes 710 while still connected via the hub 714 via a wired or wireless connection. In some embodiments, the hub 714 may be a dedicated hub—that is, a hub whose primary function is to route communications to/from the UEs from/to the network node 710b. In other embodiments, the hub 714 may be a non-dedicated hub—that is, a device which is capable of operating to route communications between the UEs and network node 710b, but which is additionally capable of operating as a communication start and/or end point for certain data channels.

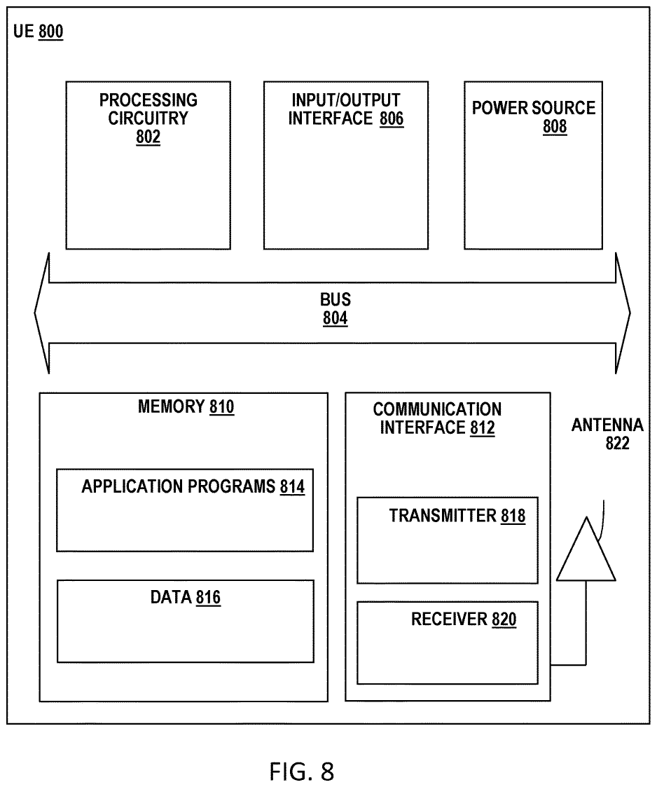

FIG. 8 shows a UE 800 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller).

Alternatively, a UE may represent a device that is not intended for sale to, or operation by, an end user but which may be associated with or operated for the benefit of a user (e.g., a smart power meter).

The UE 800 includes processing circuitry 802 that is operatively coupled via a bus 804 to an input/output interface 806, a power source 808, a memory 810, a communication interface 812, and/or any other component, or any combination thereof. Certain UEs may utilize all or a subset of the components shown in FIG. 8. The level of integration between the components may vary from one UE to another UE. Further, certain UEs may contain multiple instances of a component, such as multiple processors, memories, transceivers, transmitters, receivers, etc.

The processing circuitry 802 is configured to process instructions and data and may be configured to implement any sequential state machine operative to execute instructions stored as machine-readable computer programs in the memory 810. The processing circuitry 802 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 802 may include multiple central processing units (CPUs).

In the example, the input/output interface 806 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 800. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 808 is structured as a battery or battery pack. Other types of power sources, such as an external power source (e.g., an electricity outlet), photovoltaic device, or power cell, may be used. The power source 808 may further include power circuitry for delivering power from the power source 808 itself, and/or an external power source, to the various parts of the UE 800 via input circuitry or an interface such as an electrical power cable. Delivering power may be, for example, for charging of the power source 808. Power circuitry may perform any formatting, converting, or other modification to the power from the power source 808 to make the power suitable for the respective components of the UE 800 to which power is supplied.

The memory 810 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 810 includes one or more application programs 814, such as an operating system, web browser application, a widget, gadget engine, or other application, and corresponding data 816. The memory 810 may store, for use by the UE 800, any of a variety of various operating systems or combinations of operating systems.

The memory 810 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 810 may allow the UE 800 to access instructions, application programs and the like, stored on transitory or non-transitory memory media, to off-load data, or to upload data. An article of manufacture, such as one utilizing a communication system may be tangibly embodied as or in the memory 810, which may be or comprise a device-readable storage medium.

The processing circuitry 802 may be configured to communicate with an access network or other network using the communication interface 812. The communication interface 812 may comprise one or more communication subsystems and may include or be communicatively coupled to an antenna 822. The communication interface 812 may include one or more transceivers used to communicate, such as by communicating with one or more remote transceivers of another device capable of wireless communication (e.g., another UE or a network node in an access network). Each transceiver may include a transmitter 818 and/or a receiver 820 appropriate to provide network communications (e.g., optical, electrical, frequency allocations, and so forth). Moreover, the transmitter 818 and receiver 820 may be coupled to one or more antennas (e.g., antenna 822) and may share circuit components, software or firmware, or alternatively be implemented separately.

In the illustrated embodiment, communication functions of the communication interface 812 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 812, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 800 shown in FIG. 8.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

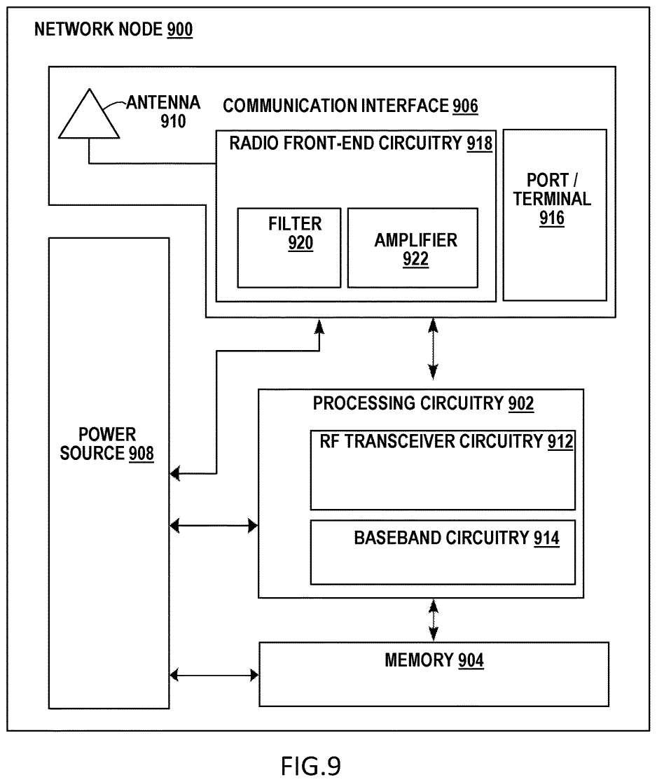

FIG. 9 shows a network node 900 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)), O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 900 includes a processing circuitry 902, a memory 904, a communication interface 906, and a power source 908. The network node 900 may be composed of multiple physically separate components (e.g., a NodeB component and a RNC component, or a BTS component and a BSC component, etc.), which may each have their own respective components. In certain scenarios in which the network node 900 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 900 may be configured to support multiple radio access technologies (RATs). In such embodiments, some components may be duplicated (e.g., separate memory 904 for different RATs) and some components may be reused (e.g., a same antenna 910 may be shared by different RATs). The network node 900 may also include multiple sets of the various illustrated components for different wireless technologies integrated into network node 900, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 900.

The processing circuitry 902 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 900 components, such as the memory 904, to provide network node 900 functionality.

In some embodiments, the processing circuitry 902 includes a system on a chip (SOC). In some embodiments, the processing circuitry 902 includes one or more of radio frequency (RF) transceiver circuitry 912 and baseband processing circuitry 914. In some embodiments, the radio frequency (RF) transceiver circuitry 912 and the baseband processing circuitry 914 may be on separate chips (or sets of chips), boards, or units, such as radio units and digital units. In alternative embodiments, part or all of RF transceiver circuitry 912 and baseband processing circuitry 914 may be on the same chip or set of chips, boards, or units.

The memory 904 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 902. The memory 904 may store any suitable instructions, data, or information, including a computer program, software, an application including one or more of logic, rules, code, tables, and/or other instructions capable of being executed by the processing circuitry 902 and utilized by the network node 900. The memory 904 may be used to store any calculations made by the processing circuitry 902 and/or any data received via the communication interface 906. In some embodiments, the processing circuitry 902 and memory 904 is integrated.

The communication interface 906 is used in wired or wireless communication of signaling and/or data between a network node, access network, and/or UE. As illustrated, the communication interface 906 comprises port(s)/terminal(s) 916 to send and receive data, for example to and from a network over a wired connection. The communication interface 906 also includes radio front-end circuitry 918 that may be coupled to, or in certain embodiments a part of, the antenna 910. Radio front-end circuitry 918 comprises filters 920 and amplifiers 922. The radio front-end circuitry 918 may be connected to an antenna 910 and processing circuitry 902. The radio front-end circuitry may be configured to condition signals communicated between antenna 910 and processing circuitry 902. The radio front-end circuitry 918 may receive digital data that is to be sent out to other network nodes or UEs via a wireless connection. The radio front-end circuitry 918 may convert the digital data into a radio signal having the appropriate channel and bandwidth parameters using a combination of filters 920 and/or amplifiers 922. The radio signal may then be transmitted via the antenna 910. Similarly, when receiving data, the antenna 910 may collect radio signals which are then converted into digital data by the radio front-end circuitry 918. The digital data may be passed to the processing circuitry 902. In other embodiments, the communication interface may comprise different components and/or different combinations of components.

In certain alternative embodiments, the network node 900 does not include separate radio front-end circuitry 918, instead, the processing circuitry 902 includes radio front-end circuitry and is connected to the antenna 910. Similarly, in some embodiments, all or some of the RF transceiver circuitry 912 is part of the communication interface 906. In still other embodiments, the communication interface 906 includes one or more ports or terminals 916, the radio front-end circuitry 918, and the RF transceiver circuitry 912, as part of a radio unit (not shown), and the communication interface 906 communicates with the baseband processing circuitry 914, which is part of a digital unit (not shown).

The antenna 910 may include one or more antennas, or antenna arrays, configured to send and/or receive wireless signals. The antenna 910 may be coupled to the radio front-end circuitry 918 and may be any type of antenna capable of transmitting and receiving data and/or signals wirelessly. In certain embodiments, the antenna 910 is separate from the network node 900 and connectable to the network node 900 through an interface or port.

The antenna 910, communication interface 906, and/or the processing circuitry 902 may be configured to perform any receiving operations and/or certain obtaining operations described herein as being performed by the network node. Any information, data and/or signals may be received from a UE, another network node and/or any other network equipment. Similarly, the antenna 910, the communication interface 906, and/or the processing circuitry 902 may be configured to perform any transmitting operations described herein as being performed by the network node. Any information, data and/or signals may be transmitted to a UE, another network node and/or any other network equipment.

The power source 908 provides power to the various components of network node 900 in a form suitable for the respective components (e.g., at a voltage and current level needed for each respective component). The power source 908 may further comprise, or be coupled to, power management circuitry to supply the components of the network node 900 with power for performing the functionality described herein. For example, the network node 900 may be connectable to an external power source (e.g., the power grid, an electricity outlet) via an input circuitry or interface such as an electrical cable, whereby the external power source supplies power to power circuitry of the power source 908. As a further example, the power source 908 may comprise a source of power in the form of a battery or battery pack which is connected to, or integrated in, power circuitry. The battery may provide backup power should the external power source fail.

Embodiments of the network node 900 may include additional components beyond those shown in FIG. 9 for providing certain aspects of the network node's functionality, including any of the functionality described herein and/or any functionality necessary to support the subject matter described herein. For example, the network node 900 may include user interface equipment to allow input of information into the network node 900 and to allow output of information from the network node 900. This may allow a user to perform diagnostic, maintenance, repair, and other administrative functions for the network node 900.

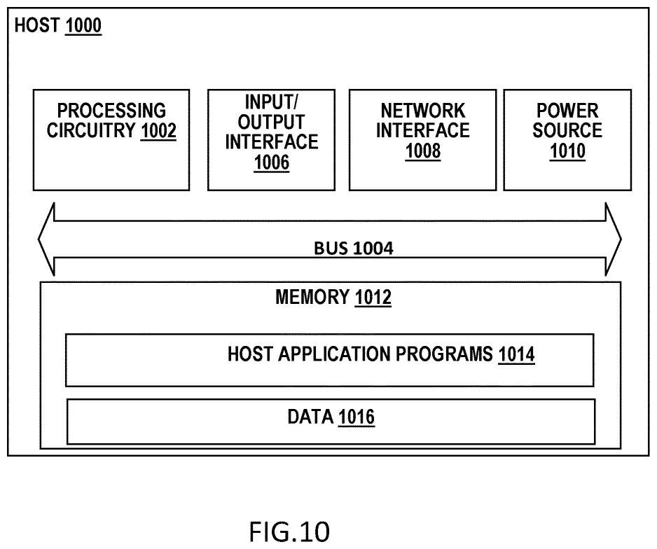

FIG. 10 is a block diagram of a host 1000, which may be an embodiment of the host 716 of FIG. 7, in accordance with various aspects described herein. As used herein, the host 1000 may be or comprise various combinations hardware and/or software, including a standalone server, a blade server, a cloud-implemented server, a distributed server, a virtual machine, container, or processing resources in a server farm. The host 1000 may provide one or more services to one or more UEs.

The host 1000 includes processing circuitry 1002 that is operatively coupled via a bus 1004 to an input/output interface 1006, a network interface 1008, a power source 1010, and a memory 1012. Other components may be included in other embodiments. Features of these components may be substantially similar to those described with respect to the devices of previous figures, such as FIGS. 8 and 9, such that the descriptions thereof are generally applicable to the corresponding components of host 1000.

The memory 1012 may include one or more computer programs including one or more host application programs 1014 and data 1016, which may include user data, e.g., data generated by a UE for the host 1000 or data generated by the host 1000 for a UE. Embodiments of the host 1000 may utilize only a subset or all of the components shown. The host application programs 1014 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1014 may also provide for user authentication and licensing checks and may periodically report health, routes, and content availability to a central node, such as a device in or on the edge of a core network. Accordingly, the host 1000 may select and/or indicate a different host for over-the-top services for a UE. The host application programs 1014 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

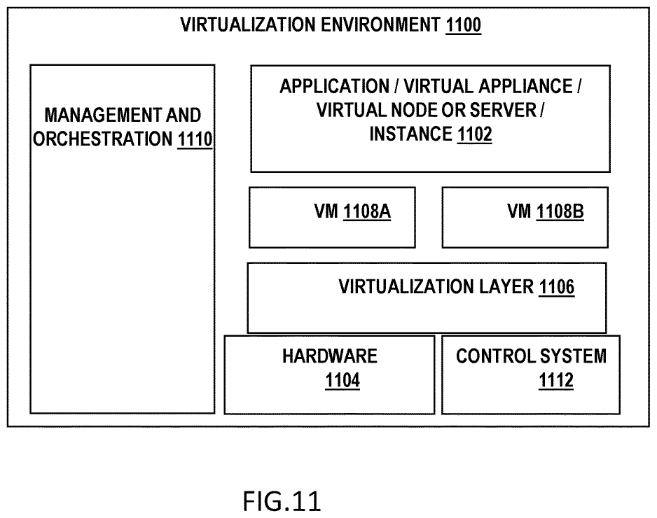

FIG. 11 is a block diagram illustrating a virtualization environment 1100 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1100 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 1100 includes components defined by the O-RAN Alliance, such as an O-Cloud environment orchestrated by a Service Management and Orchestration Framework via an O-2 interface.

Applications 1102 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1104 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1106 (also referred to as hypervisors or virtual machine monitors (VMMs)), provide VMs 1108a and 1108b (one or more of which may be generally referred to as VMs 1108), and/or perform any of the functions, features and/or benefits described in relation with some embodiments described herein. The virtualization layer 1106 may present a virtual operating platform that appears like networking hardware to the VMs 1108.

The VMs 1108 comprise virtual processing, virtual memory, virtual networking or interface and virtual storage, and may be run by a corresponding virtualization layer 1106. Different embodiments of the instance of a virtual appliance 1102 may be implemented on one or more of VMs 1108, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1108 may be a software implementation of a physical machine that runs programs as if they were executing on a physical, non-virtualized machine. Each of the VMs 1108, and that part of hardware 1104 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1108 on top of the hardware 1104 and corresponds to the application 1102.

Hardware 1104 may be implemented in a standalone network node with generic or specific components. Hardware 1104 may implement some functions via virtualization. Alternatively, hardware 1104 may be part of a larger cluster of hardware (e.g. such as in a data center or CPE) where many hardware nodes work together and are managed via management and orchestration 1110, which, among others, oversees lifecycle management of applications 1102. In some embodiments, hardware 1104 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1112 which may alternatively be used for communication between hardware nodes and radio units.

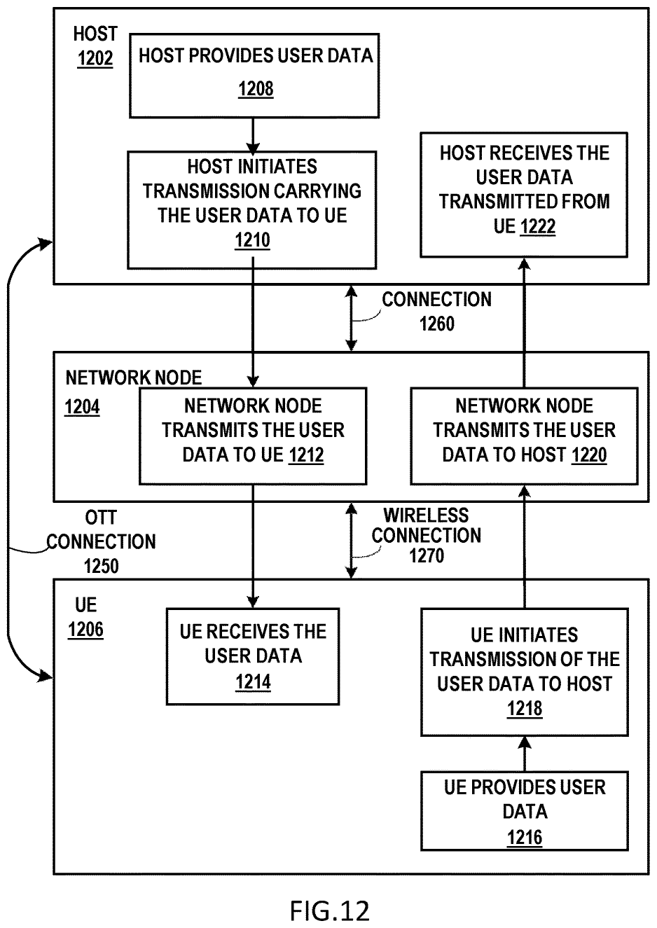

FIG. 12 shows a communication diagram of a host 1202 communicating via a network node 1204 with a UE 1206 over a partially wireless connection in accordance with some embodiments. Example implementations, in accordance with various embodiments, of the UE (such as a UE 712a of FIG. 7 and/or UE 800 of FIG. 8), network node (such as network node 710a of FIG. 7 and/or network node 900 of FIG. 9), and host (such as host 716 of FIG. 7 and/or host 1000 of FIG. 10) discussed in the preceding paragraphs will now be described with reference to FIG. 12.

Like host 1000, embodiments of host 1202 include hardware, such as a communication interface, processing circuitry, and memory. The host 1202 also includes software, which is stored in or accessible by the host 1202 and executable by the processing circuitry. The software includes a host application that may be operable to provide a service to a remote user, such as the UE 1206 connecting via an over-the-top (OTT) connection 1250 extending between the UE 1206 and host 1202. In providing the service to the remote user, a host application may provide user data which is transmitted using the OTT connection 1250.

The network node 1204 includes hardware enabling it to communicate with the host 1202 and UE 1206. The connection 1260 may be direct or pass through a core network (like core network 706 of FIG. 7) and/or one or more other intermediate networks, such as one or more public, private, or hosted networks. For example, an intermediate network may be a backbone network or the Internet.

The UE 1206 includes hardware and software, which is stored in or accessible by UE 1206 and executable by the UE's processing circuitry. The software includes a client application, such as a web browser or operator-specific “app” that may be operable to provide a service to a human or non-human user via UE 1206 with the support of the host 1202. In the host 1202, an executing host application may communicate with the executing client application via the OTT connection 1250 terminating at the UE 1206 and host 1202. In providing the service to the user, the UE's client application may receive request data from the host's host application and provide user data in response to the request data. The OTT connection 1250 may transfer both the request data and the user data. The UE's client application may interact with the user to generate the user data that it provides to the host application through the OTT connection 1250.

The OTT connection 1250 may extend via a connection 1260 between the host 1202 and the network node 1204 and via a wireless connection 1270 between the network node 1204 and the UE 1206 to provide the connection between the host 1202 and the UE 1206. The connection 1260 and wireless connection 1270, over which the OTT connection 1250 may be provided, have been drawn abstractly to illustrate the communication between the host 1202 and the UE 1206 via the network node 1204, without explicit reference to any intermediary devices and the precise routing of messages via these devices.

As an example of transmitting data via the OTT connection 1250, in step 1208, the host 1202 provides user data, which may be performed by executing a host application. In some embodiments, the user data is associated with a particular human user interacting with the UE 1206. In other embodiments, the user data is associated with a UE 1206 that shares data with the host 1202 without explicit human interaction. In step 1210, the host 1202 initiates a transmission carrying the user data towards the UE 1206. The host 1202 may initiate the transmission responsive to a request transmitted by the UE 1206. The request may be caused by human interaction with the UE 1206 or by operation of the client application executing on the UE 1206. The transmission may pass via the network node 1204, in accordance with the teachings of the embodiments described throughout this disclosure. Accordingly, in step 1212, the network node 1204 transmits to the UE 1206 the user data that was carried in the transmission that the host 1202 initiated, in accordance with the teachings of the embodiments described throughout this disclosure. In step 1214, the UE 1206 receives the user data carried in the transmission, which may be performed by a client application executed on the UE 1206 associated with the host application executed by the host 1202.

In some examples, the UE 1206 executes a client application which provides user data to the host 1202. The user data may be provided in reaction or response to the data received from the host 1202. Accordingly, in step 1216, the UE 1206 may provide user data, which may be performed by executing the client application. In providing the user data, the client application may further consider user input received from the user via an input/output interface of the UE 1206. Regardless of the specific manner in which the user data was provided, the UE 1206 initiates, in step 1218, transmission of the user data towards the host 1202 via the network node 1204. In step 1220, in accordance with the teachings of the embodiments described throughout this disclosure, the network node 1204 receives user data from the UE 1206 and initiates transmission of the received user data towards the host 1202. In step 1222, the host 1202 receives the user data carried in the transmission initiated by the UE 1206.

One or more of the various embodiments improve the performance of OTT services provided to the UE 1206 using the OTT connection 1250, in which the wireless connection 1270 forms the last segment.

In an example scenario, factory status information may be collected and analyzed by the host 1202. As another example, the host 1202 may process audio and video data which may have been retrieved from a UE for use in creating maps. As another example, the host 1202 may collect and analyze real-time data to assist in controlling vehicle congestion (e.g., controlling traffic lights). As another example, the host 1202 may store surveillance video uploaded by a UE. As another example, the host 1202 may store or control access to media content such as video, audio, VR or AR which it can broadcast, multicast or unicast to UEs. As other examples, the host 1202 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1250 between the host 1202 and UE 1206, in response to variations in the measurement results. The measurement procedure and/or the network functionality for reconfiguring the OTT connection may be implemented in software and hardware of the host 1202 and/or UE 1206. In some embodiments, sensors (not shown) may be deployed in or in association with other devices through which the OTT connection 1250 passes; the sensors may participate in the measurement procedure by supplying values of the monitored quantities exemplified above, or supplying values of other physical quantities from which software may compute or estimate the monitored quantities. The reconfiguring of the OTT connection 1250 may include message format, retransmission settings, preferred routing etc.; the reconfiguring need not directly alter the operation of the network node 1204. Such procedures and functionalities may be known and practiced in the art. In certain embodiments, measurements may involve proprietary UE signaling that facilitates measurements of throughput, propagation times, latency and the like, by the host 1202. The measurements may be implemented in that software causes messages to be transmitted, in particular empty or ‘dummy’ messages, using the OTT connection 1250 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### LIST OF EMBODIMENTS

1. A method performed by a user equipment for performing performance monitoring of an artificial intelligence (AI)/machine learning (ML) model, the method comprising:
   receiving, from a network node, model monitoring configuration;
   deriving, from the model monitoring configuration, a model performance monitoring result for the AI/ML model; and
   reporting the model performance monitoring result for the AI/ML model to the network node.
2. The method of embodiment 1, wherein the model monitoring configuration includes one or more of the following:
   an identification of the AI/ML model;
   one or more configurations for collecting a monitoring data set and determining model performance result;
   a definition of an intermediate key performance indicator (KPI) per monitoring data sample;
   a definition of model monitoring metrics;
   a content of the model performance monitoring result; and
   a content of the reporting of the model performance monitoring result.
3 The method of embodiment 2, wherein the one or more configurations for collecting the monitoring data set and determining model performance result includes one or more of the following:
   an identification of a condition such as a network antenna/beam configuration and/or an identifier of one or more areas/cells from which monitoring data samples are to be collected;
   measurement reference signal (RS) configurations for collecting measurement samples;
   configuration for obtaining or receiving data samples from another node;
   a number of samples to be collected for constructing the monitoring data set;
   a constraint on the number of samples that are collected;
   a time window for collecting the number of samples;
   a report interval for reporting of the model performance monitoring result; and
   a condition for reporting of the model performance monitoring result to the network node.
4. The method of embodiment 3, wherein the AI/ML model is for a two-sided channel state information (CSI)-compression use case, and wherein the configuration for obtaining or receiving data samples from another node include configuration for obtaining or receiving reconstructed CSI from a network node-part model output or from a proxy model.
5. The method of embodiment 3, wherein the AI/ML model is for an assisted positioning method with UE-side model, and wherein the configuration for obtaining or receiving data samples from another node includes configuration for obtaining or receiving information from a location server for an estimated ground truth of an output of the AI/ML model.
6. The method of any of the embodiments 2-5, wherein the definition of the intermediate KPI per monitoring data sample is one of:
   a squared generalized cosine similarity (SGCS) and/or normalized mean square error (NMSE) of reconstructed channel state information (CSI) and measured CSI;
   a L1-reference signal received power (RSRP) value difference between a predicted value and a measured value of a same Synchronization Signal Block (SSB)/CSI-reference signal (RS) beam; and
   a time of arrival (ToA) value difference between the ToA produced at model output and an estimated ToA derived from an estimated target UE location.
7. The method of any of the embodiments 2-6, wherein the definition of model monitoring metrics is one of:
   a Cumulative Density Function (CDF) at X percentile of intermediate key performance indicators (KPIs) associated with collected monitoring data samples;
   a mean and/or variance of the intermediate KPIs associated with collected monitoring data samples; and
   a percentage of collected monitoring data samples for which the intermediate KPIs associated with the collected monitoring data samples fulfill a condition.
8. The method of any of the embodiments 2-7, wherein the content of the model performance monitoring result includes one or more of:
   a measured quantity result for each measured RS;
   intermediate KPI per monitoring data sample;
   one or more model monitoring metrics; and
   a flag indicating whether the one or more model monitoring metrics fulfill a condition.
9 The method of any of the embodiments 2-8, wherein the content of the reporting of the model performance monitoring result includes one or more of performance of the model performance monitoring results.
10. The method of any of the previous embodiments, wherein the network node is one of a gNB, OAM, and a core network node.
11. The method of any of the previous embodiments, further comprising:
   providing user data; and
   forwarding the user data to a host via the transmission to the network node.
12. A method performed by a network node for configuring a user equipment (UE) to perform performance monitoring of an artificial intelligence (AI)/machine learning (ML) model, the method comprising:
   signaling, to the UE, model monitoring configuration to cause the UE to derive a model performance monitoring result for the AI/ML model; and
   receiving, from the UE, a report of the model performance monitoring result.
13. The method of embodiment 12, wherein the model monitoring configuration includes one or more of the following:
   an identification of the AI/ML model;
   one or more configurations for collecting a monitoring data set and determining model performance result;
   a definition of an intermediate key performance indicator (KPI) per monitoring data sample;
   a definition of model monitoring metrics;
   a content of the model performance monitoring result; and
   a content of the reporting of the model performance monitoring result.
14. The method of embodiment 13, wherein the one or more configurations for collecting the monitoring data set and determining model performance result includes one or more of the following:
   an identification of a condition such as a network antenna/beam configuration and/or an identifier of one or more areas/cells from which monitoring data samples are to be collected;
   measurement reference signal (RS) configurations for collecting measurement samples;
   configuration for obtaining or receiving data samples from another node;
   a number of samples to be collected for constructing the monitoring data set;
   a constraint on the number of samples that are collected;
   a time window for collecting the number of samples;
   a report interval for reporting of the model performance monitoring result; and
   a condition for reporting of the model performance monitoring result to the network node.
15. The method of embodiment 14, wherein the AI/ML model is for a two-sided channel state information (CSI)-compression use case, and wherein the configuration for obtaining or receiving data samples from another node include configuration for obtaining or receiving reconstructed CSI from a network node-part model output or from a proxy model.
16. The method of embodiment 14, wherein the AI/ML model is for an assisted positioning method with UE-side model, and wherein the configuration for obtaining or receiving data samples from another node includes configuration for obtaining or receiving information from a location server for an estimated ground truth of an output of the AI/ML model.
17. The method of any of the embodiments 13-16, wherein the definition of the intermediate KPI per monitoring data sample is one of:
   a squared generalized cosine similarity (SGCS) and/or normalized mean square error (NMSE) of reconstructed channel state information (CSI) and measured CSI;
   a L1-reference signal received power (RSRP) value difference between a predicted value and a measured value of a same Synchronization Signal Block (SSB)/CSI-reference signal (RS) beam; and
   a time of arrival (ToA) value difference between the ToA produced at model output and an estimated ToA derived from an estimated target UE location.
18. The method of any of the embodiments 13-17, wherein the definition of model monitoring metrics is one of:
   a Cumulative Density Function (CDF) at X percentile of intermediate key performance indicators (KPIs) associated with collected monitoring data samples;
   a mean and/or variance of the intermediate KPIs associated with collected monitoring data samples;
   a percentage of collected monitoring data samples for which the intermediate KPIs associated with the collected monitoring data samples fulfill a condition.
19. The method of any of the embodiments 13-18, wherein the content of the model performance monitoring result includes one or more of:
   a measured quantity result for each measured RS;
   intermediate KPI per monitoring data sample;
   one or more model monitoring metrics; and
   a flag indicating whether the one or more model monitoring metrics fulfill a condition.
20. The method of any of the embodiments 13-19, wherein the content of the reporting of the model performance monitoring result includes one or more of performance of the model performance monitoring results.
21. The method of any of the previous Group B embodiments, wherein the network node is one of a gNB, OAM, and a core network node.
22. The method of any of the previous Group B embodiments, further comprising:
   obtaining user data; and
   forwarding the user data to a host or a user equipment.
23. A user equipment for performing performance monitoring of an artificial intelligence (AI)/machine learning (ML) model, comprising:
   processing circuitry configured to perform any of the steps of any of the embodiments 1-11; and
   power supply circuitry configured to supply power to the processing circuitry.
24. A network node for configuring a user equipment (UE) to perform performance monitoring of an artificial intelligence (AI)/machine learning (ML) model, the network node comprising:
   processing circuitry configured to perform any of the steps of any of the embodiments 12-22;
   power supply circuitry configured to supply power to the processing circuitry.
25. A user equipment (UE) for performing performance monitoring of an artificial intelligence (AI)/machine learning (ML) model, the UE comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the embodiments 1-11;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE.
26. A host configured to operate in a communication system to provide an over-the-top (OTT) service, the host comprising:
   processing circuitry configured to provide user data; and
   a network interface configured to initiate transmission of the user data to a network node in a cellular network for transmission to a user equipment (UE), the network node having a communication interface and processing circuitry, the processing circuitry of the network node configured to perform any of the operations of any of the embodiments 12-22 to transmit the user data from the host to the UE.
27. The host of the previous embodiment, wherein:
   the processing circuitry of the host is configured to execute a host application that provides the user data; and
   the UE comprises processing circuitry configured to execute a client application associated with the host application to receive the transmission of user data from the host.
28. A method implemented in a host configured to operate in a communication system that further includes a network node and a user equipment (UE), the method comprising:
   providing user data for the UE; and
   initiating a transmission carrying the user data to the UE via a cellular network comprising the network node, wherein the network node performs any of the operations of any of the embodiments 12-22 to transmit the user data from the host to the UE.
29. The method of the previous embodiment, further comprising, at the network node, transmitting the user data provided by the host for the UE.
30. The method of any of the previous 2 embodiments, wherein the user data is provided at the host by executing a host application that interacts with a client application executing on the UE, the client application being associated with the host application.
31. A communication system configured to provide an over-the-top (OTT) service, the communication system comprising:
   a host comprising:
   processing circuitry configured to provide user data for a user equipment (UE), the user data being associated with the over-the-top service; and
   a network interface configured to initiate transmission of the user data toward a cellular network node for transmission to the UE, the network node having a communication interface and processing circuitry, the processing circuitry of the network node configured to perform any of the operations of any of the embodiments 12-22 to transmit the user data from the host to the UE.
32. The communication system of the previous embodiment, further comprising:
   the network node; and/or

### the UE.

33. A host configured to operate in a communication system to provide an over-the-top (OTT) service, the host comprising:
   processing circuitry configured to initiate receipt of user data; and
   a network interface configured to receive the user data from a network node in a cellular network, the network node having a communication interface and processing circuitry, the processing circuitry of the network node configured to perform any of the operations of any of the embodiments 12-22 to receive the user data from a user equipment (UE) for the host.
34. The host of the previous 2 embodiments, wherein:
   the processing circuitry of the host is configured to execute a host application that receives the user data; and
   the host application is configured to interact with a client application executing on the UE, the client application being associated with the host application.
35. The host of the any of the previous 2 embodiments, wherein the initiating receipt of the user data comprises requesting the user data.
36. A method implemented by a host configured to operate in a communication system that further includes a network node and a user equipment (UE), the method comprising:
   at the host, initiating receipt of user data from the UE, the user data originating from a transmission which the network node has received from the UE, wherein the network node performs any of the steps of any of the embodiments 12-22 to receive the user data from the UE for the host.
37. The method of the previous embodiment, further comprising at the network node, transmitting the received user data to the host.
38. A host configured to operate in a communication system to provide an over-the-top (OTT) service, the host comprising:
   processing circuitry configured to provide user data; and
   a network interface configured to initiate transmission of the user data to a cellular network for transmission to a user equipment (UE), wherein the UE comprises a communication interface and processing circuitry, the communication interface and processing circuitry of the UE being configured to perform any of the operations of any of the Group A embodiments to receive the user data from the host.
39. The host of the previous embodiment, wherein the cellular network further includes a network node configured to communicate with the UE to transmit the user data to the UE from the host.
40. The host of the previous 2 embodiments, wherein:
   the processing circuitry of the host is configured to execute a host application, thereby providing the user data; and
   the host application is configured to interact with a client application executing on the UE, the client application being associated with the host application.
41. A method implemented by a host operating in a communication system that further includes a network node and a user equipment (UE), the method comprising:
   providing user data for the UE; and
   initiating a transmission carrying the user data to the UE via a cellular network comprising the network node, wherein the UE performs any of the operations of any of the embodiments 1-11 to receive the user data from the host.
42. The method of the previous embodiment, further comprising:
   at the host, executing a host application associated with a client application executing on the UE to receive the user data from the host application.
43. The method of the previous embodiment, further comprising:
   at the host, transmitting input data to the client application executing on the UE, the input data being provided by executing the host application,
   wherein the user data is provided by the client application in response to the input data from the host application.
44. A host configured to operate in a communication system to provide an over-the-top (OTT) service, the host comprising:
   processing circuitry configured to provide user data; and
   a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the embodiments 1-11 to transmit the user data to the host.
45. The host of the previous embodiment, wherein the cellular network further includes a network node configured to communicate with the UE to transmit the user data from the UE to the host.
46. The host of the previous 2 embodiments, wherein:
   the processing circuitry of the host is configured to execute a host application, thereby providing the user data; and
   the host application is configured to interact with a client application executing on the UE, the client application being associated with the host application.
47. A method implemented by a host configured to operate in a communication system that further includes a network node and a user equipment (UE), the method comprising:
   at the host, receiving user data transmitted to the host via the network node by the UE, wherein the UE performs any of the steps of any of the embodiments 1-11 to transmit the user data to the host.
48. The method of the previous embodiment, further comprising:
   at the host, executing a host application associated with a client application executing on the UE to receive the user data from the UE.
49. The method of the previous 2 embodiments, further comprising:
   at the host, transmitting input data to the client application executing on the UE, the input data being provided by executing the host application,
   wherein the user data is provided by the client application in response to the input data from the host application.

1. A method performed by a user equipment for performing performance monitoring of an artificial intelligence (AI)/machine learning (ML) model, the method comprising:
receiving, from a network node, model monitoring configuration;
deriving, from the model monitoring configuration, a model performance monitoring result for the AI/ML model; and
reporting the model performance monitoring result for the AI/ML model to the network node.

2. The method of claim 1, wherein the model monitoring configuration comprises identification of the AI/ML model wherein the AI/ML model is for one of Channel State Information (CSI) compression, CSI prediction, beam management and/or positioning.

3. The method of claim 1, wherein the model performance monitoring results comprises:
an intermediate key performance indicator (KPI) per monitoring data sample, intermediate KPI statistics associated with a monitoring data set, percentage of monitoring data samples within a monitoring dataset for which the intermediate KPI fulfills a certain condition, a flag indicating whether the model is functioning or not.

4. The method of claim 1, wherein the model monitoring configuration comprises one or more of the following:
an identification of the AI/ML model;
one or more configurations for collecting a monitoring data set and determining model performance result;
a definition of an intermediate key performance indicator (KPI) per monitoring data sample;
a definition of model monitoring metrics;
a content of the model performance monitoring result; and
a content of the reporting of the model performance monitoring result.

5. The method of claim 1, wherein the model monitoring configuration comprises one or more configurations for collecting a monitoring data set and determining model performance result comprising one or more of the following:
an identification of a condition such as a network antenna/beam configuration and/or an identifier of one or more areas/cells from which monitoring data samples are to be collected;
measurement reference signal (RS) configurations for collecting measurement samples;
configuration for obtaining or receiving data samples from another node;
a number of samples (K) to be collected for constructing the monitoring data set;
a constraint on the number of samples that are collected;
a time window for collecting the number of samples;
a report interval for reporting of the model performance monitoring result; and
a condition for reporting of the model performance monitoring result to the network node.

6. The method of claim 5, wherein the condition for reporting the model performance monitoring result to the network node, comprises one or more threshold configured by the network node for an intermediate KPI value or a model monitoring metric.

7. The method of claim 5, wherein the AI/ML model is for a two-sided channel state information (CSI)-compression, and wherein the configuration for obtaining or receiving data samples from another node comprises configuration for obtaining or receiving reconstructed CSI from a network node-part model output or from a proxy model.

8. The method of claim 5, wherein the AI/ML model is for an assisted positioning method with UE-side model, and wherein the configuration for obtaining or receiving data samples from another node comprises configuration for obtaining or receiving information from a location server for an estimated ground truth of an output of the AI/ML model.

9. The method of claim 3 wherein the intermediate KPI per monitoring data sample is one of:
a squared generalized cosine similarity (SGCS) and/or normalized mean square error (NMSE) of reconstructed channel state information (CSI) and measured CSI;
a L1-reference signal received power (RSRP) value difference between a predicted value and a measured value of a same Synchronization Signal Block (SSB)/CSI-reference signal (RS) beam; and
a time of arrival (ToA) value difference between the ToA produced at model output and an estimated ToA derived from an estimated target UE location.

10. The method of claim 4, wherein the definition of model monitoring metrics is one of:
a Cumulative Density Function (CDF) at X percentile of intermediate key performance indicators (KPIs) associated with collected monitoring data samples;
a mean and/or variance of the intermediate KPIs associated with collected monitoring data samples; and
a percentage of collected monitoring data samples for which the intermediate KPIs associated with the collected monitoring data samples fulfill a condition.

11. The method of claim 4, wherein the content of the model performance monitoring result includes one or more of:
a measured quantity result for each measured RS;
intermediate KPI per monitoring data sample;
one or more model monitoring metrics; and
a flag indicating whether the one or more model monitoring metrics fulfill a condition.

12. The method of claim 4, wherein the content of the reporting of the model performance monitoring result includes performance of the model performance monitoring results.

13. A method performed by a network node for configuring a user equipment (UE) to perform performance monitoring of an artificial intelligence (AI)/machine learning (ML) model, the method comprising:
signaling, to the UE, model monitoring configuration to cause the UE to derive a model performance monitoring result for the AI/ML model; and
receiving, from the UE, a report of the model performance monitoring result.

14. The method of claim 13, wherein the model monitoring configuration includes one or more of the following:
an identification of the AI/ML model;
one or more configurations for collecting a monitoring data set and determining model performance result;
a definition of an intermediate key performance indicator (KPI) per monitoring data sample;
a definition of model monitoring metrics;
a content of the model performance monitoring result; and
a content of the reporting of the model performance monitoring result.

15. The method of claim 14, wherein the one or more configurations for collecting the monitoring data set and determining model performance result includes one or more of the following:
an identification of a condition such as a network antenna/beam configuration and/or an identifier of one or more areas/cells from which monitoring data samples are to be collected;
measurement reference signal (RS) configurations for collecting measurement samples;
configuration for obtaining or receiving data samples from another node;
a number of samples to be collected for constructing the monitoring data set;
a constraint on the number of samples that are collected;
a time window for collecting the number of samples;
a report interval for reporting of the model performance monitoring result; and
a condition for reporting of the model performance monitoring result to the network node.

16. The method of claim 15, wherein the AI/ML model is for a two-sided channel state information (CSI)-compression use case, and wherein the configuration for obtaining or receiving data samples from another node include configuration for obtaining or receiving reconstructed CSI from a network node-part model output or from a proxy model.

17. The method of claim 15, wherein the AI/ML model is for an assisted positioning method with UE-side model, and wherein the configuration for obtaining or receiving data samples from another node includes configuration for obtaining or receiving information from a location server for an estimated ground truth of an output of the AI/ML model.

18. The method of claim 14, wherein the definition of the intermediate KPI per monitoring data sample is one of:
a squared generalized cosine similarity (SGCS) and/or normalized mean square error (NMSE) of reconstructed channel state information (CSI) and measured CSI;
a L1-reference signal received power (RSRP) value difference between a predicted value and a measured value of a same Synchronization Signal Block (SSB)/CSI-reference signal (RS) beam; and
a time of arrival (ToA) value difference between the ToA produced at model output and an estimated ToA derived from an estimated target UE location.

19. A user equipment for performing performance monitoring of an artificial intelligence (AI)/machine learning (ML) model, comprising:
processing circuitry configured to perform the following operations:
receiving, from a network node, model monitoring configuration,
deriving, from the model monitoring configuration, a model performance monitoring result for the AI/ML model, and
reporting the model performance monitoring result for the AI/ML model to the network node; and
power supply circuitry configured to supply power to the processing circuitry.

20. (canceled)
